(19) United States
(12) Patent Application Publication
(10) Pub. No.: US 2016/0020639 A1
(43) Pub. Date: Jan. 21, 2016

(54) METHODS AND SYSTEMS FOR SIMULTANEOUSLY WIRELESSLY CHARGING PORTABLE DEVICES USING CUSTOM-DESIGNED AND RETRO-DESIGNED POWER CONTROL AND SUPPLY ASSEMBLIES AND ARCHITECTURAL STRUCTURES FACILITATING HANDS-FREE OPERATION OF THE PORTABLE DEVICES AND INTERACTION THEREWITH

(71) Applicants: PAVAN PUDIPEDDI, AUSTIN, TX (US); ANANDARAM KATRAGADDA, BANGALORE (IN); NAVEEN CHAVA, BANGALORE (IN)

(72) Inventors: PAVAN PUDIPEDDI, AUSTIN, TX (US); ANANDARAM KATRAGADDA, BANGALORE (IN); NAVEEN CHAVA, BANGALORE (IN)

(21) Appl. No.: 14/803,015

(22) Filed: Jul. 17, 2015

Related U.S. Application Data
(60) Provisional application No. 62/025,509, filed on Jul. 17, 2014.

(51) Int. Cl. H02J 7/02; H04M 1/60; H02J 7/00

(52) U.S. Cl. CPC H02J 7/025; H02J 7/0042; H02J 7/0027; H04M 1/6066

(57) ABSTRACT

Embodiments of the present invention specifically relate to a system for simultaneously wirelessly charging portable rechargeable devices and facilitating hands-free operation therewith. The system comprises at least one of a wall mountable and integrable electric switch and socket assembly, wherein the assembly comprises a rear panel comprising at least one of a switch socket outlet and display, a front panel comprising a wireless charging unit with free positioning capability and improved coil and shield structure and a structurally adaptable coupling member for coupling the front panel to the rear panel, at least a portable computing and communications device removably positioned on the wireless charging unit and a wireless speaker subsystem, wherein the display is wirelessly coupled to the portable computing and communications device.

### CROSS-REFERENCE TO RELATED APPLICATIONS

This application claims benefit of the U.S. Provisional Patent Application No. 62/025,509 filed Jul. 17, 2014, which is incorporated herein by reference in its entirety.

### BACKGROUND OF THE INVENTION

1. Field of the Invention

Embodiments of the present invention generally relate to wireless power transfer, and more particularly, to simultaneously wirelessly charging portable devices using custom-designed and retro-designed power control and supply assemblies and architectural structures facilitating hands-free operation of the portable devices, and interaction therewith, with enhanced qualitative and quantitative parameters, such as economical, easy usability, seamless, streamlined adaptive free positioning capability, minimal cross coupling and crosstalk, improved shield structure, improved multi-layer coil configuration, hands-free operability and interactivity, minimal Electromagnetic Interference (EMI) and thermal losses.

2. Description of the Related Art

Wireless or contactless battery charging has undergone some developments in recent years owing to the enhanced user experience and reliability of not having to use connectors, and the advantages of having universal wireless chargers for any kind of electronic devices, like laptops, mobiles etc.

One major problem is free positioning of portable devices on a wireless charger thereby facilitating seamless charging of the portable devices thereupon.

Some solutions for charging multiple mobile phones simultaneously provide for a common transmitter pad, wherein one or more independent charging systems may be used. However, the seamless free positioning capability is lost on account of physical demarcation between the independent charging systems.

In certain scenarios involving charging of multiple mobile phones using a common charger pad, highly resonant wireless power transfer provides a better user experience in terms of three dimensional free positioning capabilities. However, the total cost of the equipment turns out to be higher on account of usage of the advanced technology, in addition to the separate communications requirements that needs to be built into the wireless charger. Thus, highly resonant wireless power transfer and similar technologies may not find wide acceptance in a worldwide consumer market, unless costs are acceptable. Additionally, the highly resonant wireless power transfer and similar technologies may fail to charge existing mobile phones that already have wireless power capability.

In certain scenarios involving charging of at least one of a single portable computing and communications device using the free positioning capability, and at least a pair of the portable computing and communication devices, there is likelihood or probability of occurrence of one or more events, such as at least one of power transfer and communications events, at least one of simultaneously and separately, owing to at least a pair of transmitter coils comprising the transmitter coil array, in any point in time. In general, an electromagnetic shield that serves the transmitter coils, in entirety, as a common electromagnetic shield is used. The electromagnetic shield maximizes the power transfer efficiency via directing the flux paths. However, as a consequence, the electromagnetic shield provides for a common impedance path thereby resulting in cross-interference amid two or more transmitter coils.

One solution to the problem of cross-interference is introduction of a gap in the electromagnetic shield thereby facilitating elimination of cross-interference amid two or more transmitter coils. However, there has to be a trade-off between introduction of the gap and corresponding impact on the efficiency of power transfer.

The proliferation of peripheral electronic devices in office, retail shop and home environments demands readily accessible sources of power. Home, retail shop and office infrastructure as well as furniture components, such as walls, ceilings, shopfronts or storefronts, desks and partition systems, typically include power outlets, and associated cablings and power in-feed mechanisms, built into the components. A wired connection is established between an alternating current (AC) power source and an electronic device through a series of sockets, plugs and cables. However, the requirement of cables limit the mobility, configurability as well as adaptability of the furniture, home and retail shop infrastructure components and require power outlets to be available in close proximity to the furniture and infrastructure components to avoid stringing cable in open floor and wall spaces. Peripheral electronic devices, such as portable and mobile devices include phones, portable computers, music players, and personal digital assistants. Each electronic device requires a source of power which typically comprises an AC plug and a power converter to convert AC power to any of a plurality of direct current (DC) power levels. An unintended consequence of the proliferation of peripheral electronic devices is the proliferation of power converters, power sources, plugs and cables, which clutter the office and home environments. Another unintended consequence is the loss of mobility, configurability as well as adaptability of articles of furniture, retail shop and home infrastructure, such as tables, conference tables, light boxes, and the like, due to the tethering of power supply and distribution cables.

Therefore, there is still a need for the design and implementation of methods and systems for streamlined, simultaneous wireless charging of portable devices using custom-designed wired power control and supply assembly facilitating hands-free operation of the portable devices, and interaction therewith, with enhanced qualitative and quantitative parameters, such as economical, easy usability, seamless, streamlined adaptive free positioning capability, minimal cross coupling and crosstalk, improved shield structure, improved multi-layer coil configuration, hands-free operability and interactivity, minimal Electromagnetic Interference (EMI) and thermal losses.

### SUMMARY OF THE INVENTION

Embodiments of the present invention specifically relate to a system and method for seamlessly and simultaneously wirelessly charging portable rechargeable devices, the system comprising a charging subsystem comprising a controller, an electromagnetic shield for maximization of power transfer efficiency, and a transmitter coil array comprising a first plurality of transmitter coils in juxtaposition and coupled to the electromagnetic shield, and each of a second plurality of transmitter coils overlappingly coupled to at least a pair of the first plurality of transmitter coils in juxtaposition and positioned thereunder, and a controller for sequentially scanning each of the transmitter coils in the transmitter coil array and selectively activating and deactivating the transmitter coils based on the detection of presence of receiver coils positioned at any position relative to the transmitter coils, and a portable chargeable device comprising a receiver coil, wherein the system facilitates maximization of power transfer efficiency while minimization of cross-interference between the transmitter coils in juxtaposition.

Yet other embodiments of the present invention specifically relate to a method for design and implementation of a system facilitating seamless and simultaneous wireless charging of portable rechargeable devices with free positioning capability. The method comprises forming a plurality of customized shield structures, wherein the at least one of the customized shield structures comprises one or more shield blocks and at least one of interposed and sandwiched exploitable regions spaces therebetween, thereby facilitating minimization of inter-shield block Electromagnetic Interference (EMI), organizing one or more transmitter coils in at least one of a plurality of customized coil configurations to form at least one transmitter coil array mounted on the customized shield structures such that the customized coil configurations facilitate further minimization of inter-coil Electromagnetic Interference (EMI), wherein the combination of at least one customized shield structure and correspondingly customized coil configuration facilitates overall or consolidated minimization of EMI, and deploying at least one processor for implementation of a operational control logic for management of interoperability amid the transmitter coils via at least one of selective activation, deactivation and a combination thereof of the transmitter coils upon detection of one or more receiver coils coupled to the portable rechargeable devices, wherein the portable rechargeable devices are at any position relative to the transmitter coils for purposes of charging.

Embodiments of the present invention specifically relate to a system for simultaneously wirelessly charging portable chargeable/rechargeable devices, using custom designed at least one of wall integrable and mountable electric switch and socket assembly, whilst facilitating at least one of hands-free (hands-off) and hands-on (hands-engaged) operation of the portable rechargeable devices and interaction therewith, and methods therefor.

Embodiments of the present invention specifically relate to a system for simultaneously wirelessly charging portable rechargeable devices and facilitating hands-free operation therewith. The system comprises at least one of a wall mountable and integrable electric switch and socket assembly, wherein the assembly comprises a rear panel comprising at least one of a switch socket outlet and display, a front panel comprising a wireless charging unit with free positioning capability and improved coil and shield structure and a structurally adaptable coupling member for coupling the front panel to the rear panel, at least a portable computing and communications device removably positioned on the wireless charging unit and a wireless speaker subsystem, wherein the display is wirelessly coupled to the portable computing and communications device.

Embodiments of the present invention relate to system facilitating at least one of hands-free (hands-off) and hands-on (hands-engaged) operation of the portable computing and communications devices, and interaction therewith, correspondingly via performance of at least one of hand-initiated touch actions on, or using, 1) a universal remote control therefor and 2) one or more touch sensitive secondary multiple corresponding displays therefor, for instance one or more second screen devices, and 1) integrated touch sensitive displays of the portable computing and communications devices and 2) other input devices coupled thereto, in that order, whilst the portable computing and communications devices may be still subjected to simultaneous wireless charging. In some scenarios involving hands-free (hands-off) operation of the portable computing and communications devices, the system may facilitate performance of one or more hands-free (hands-off) tasks on the portable computing and communications devices in at least one of remote-controlled and touch-sensitive mode, such as viewing, attending or responding to incoming calls, making outgoing calls, accessing, reading and responding to incoming messages, creating or writing and sending outgoing messages, accessing, retrieving, and executing (implementing, viewing and listening) mobile applications, multimedia files and the like.

Embodiments of the present invention generally relate to a system for mounting and reconfiguring electrical loads over wirelessly powered physical surfaces. The system comprises at least one of a customized wireless power capable and retrofitted wireless power enabled physical surface. The physical surface comprises at least one physical surface module. Each physical surface module comprises a first visible facet, and a second invisible facet. The second invisible facet is parallely opposed to the first visible facet. The second invisible facet comprises at least one of a single large transmitter coil, a sequential and random array of a plurality of relatively small transmitter coil, wherein the transmitter coil is capable of at least one of wirelessly powering one or more electrical loads coupled to the physical surface.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 depicts a perspective view of the system for wirelessly charging a portable rechargeable device whilst facilitating hands-free operation of the portable rechargeable device and interaction therewith using custom designed at least one of wall integrable and mountable electric switch and socket assembly, according to one or more embodiments;

FIG. 2 depicts a snapshot of the wall mountable electric switch and socket assembly in which the rear panel is externally, fixedly removably coupled to a wall and in which the front panel is in open or folded out state, according to one or more embodiments;

FIG. 3 depicts the wall integrable electric switch and socket assembly in which the rear panel is at least one of partially internally and partially externally, fixedly removably coupled to a wall, according to one or more embodiments;

FIG. 4 depicts a detailed block diagram of the wireless charging unit 132, of FIG. 1, for optionally simultaneously wirelessly charging portable chargeable/rechargeable devices using wireless inductive power transfer with seamless free positioning capability and improved shield structure, according to one or more embodiments;

FIG. 5 depicts an exemplary potential overall physical configuration in connection with the charging subunit 402, and transmitter coil array 410 thereof, of FIG. 4, in accordance with one or more embodiments;

FIGS. 6A-F depicts an assortment of possibilities, and corresponding use case scenarios, in connection with the positioning of the portable chargeable devices 404 relative to the charging subunit 402, of FIG. 4, in accordance with one or more embodiments;

FIG. 7 depicts a flow diagram for a method for at least one of selectively activating and deactivating one or more transmitter coils constituting the transmitter coil array, in accordance with one or more embodiments;

FIG. 8A depicts an exemplary second potential overall physical configuration in connection with the charging subunit 402, and transmitter coil array 410 thereof, of FIG. 4, in accordance with one or more embodiments;

FIG. 8B depicts a third potential overall physical configuration in connection with the charging subunit 402, and transmitter coil array 410 thereof, of FIG. 4, in accordance with one or more embodiments;

FIG. 9A depicts a fourth potential overall physical configuration in connection with the charging subunit 402, and transmitter coil array 410 thereof, of FIG. 4, in accordance with one or more embodiments;

FIG. 9B depicts a fifth potential overall physical configuration in connection with the charging subunit 402, and transmitter coil array 410 thereof, of FIG. 4, in accordance with one or more embodiments;

FIG. 10A depicts a seventh potential overall physical configuration in connection with the charging subunit 402, and transmitter coil array 410 thereof, of FIG. 4, in accordance with one or more embodiments;

FIG. 10B depicts an eighth potential overall physical configuration in connection with the charging subunit 402, and transmitter coil array 410 thereof, of FIG. 4, in accordance with one or more embodiments;

FIG. 11 depicts a flow diagram of a method for design and implementation of a system facilitating seamless and simultaneous wireless charging of portable rechargeable devices with Adaptive Positioning Free (APF) capability, according to one or more embodiments;

FIGS. 12A-B correspondingly depict the customized and retrofitted systems for mounting and positionally reconfiguring electrical loads over at least one of an integrable and a mountable, customized wireless power capable and retrofitted wireless power enabled physical surfaces with an identical first potential physical configuration therefor, according to one or more embodiments;

FIGS. 13A-B correspondingly depict the customized and retrofitted systems for mounting and reconfiguring electrical loads over at least one of an integrable and a mountable, customized wireless power capable and retrofitted wireless power enabled physical surfaces with an identical second potential physical configuration therefor, according to one or more embodiments;

FIG. 14A depicts a first potential configuration in connection with the plurality of transmitter coils 1206 fixedly removably coupled to the rear facet of the at least one panel and block, according to one or more embodiments;

FIG. 14B depicts a second potential configuration in connection with the plurality of transmitter coils 1206 fixedly removably coupled to the rear facet of the at least one panel and block, according to one or more embodiments;

FIG. 15 depicts deployment of the systems for mounting and reconfiguring electrical loads over at least one of customized and retrofitted wirelessly powered physical surfaces in a storefront (or shopfront), according to one or more embodiments; and

FIG. 16 depicts a computer system that may be a computing device and may be utilized in various embodiments of the present invention.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the methods and systems for simultaneously wirelessly charging portable devices using custom-designed and retro-designed power control and supply assemblies and architectural structures facilitating hands-free operation of the portable devices and interaction therewith, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the methods and systems for simultaneously wirelessly charging portable devices using custom-designed and retro-designed power control and supply assemblies and architectural structures facilitating hands-free operation of the portable devices and interaction therewith defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of a method and system for wirelessly charging portable rechargeable devices using wall integrable or mountable electric switch and socket assemblies based on wireless inductive power transfer with enhanced qualitative and quantitative parameters, such as economical, easy usability, seamless free positioning capability, minimal cross coupling and crosstalk, improved shield structure, minimal Electromagnetic Interference (EMI) and thermal losses. In the following detailed description, numerous specific details are set forth to provide a thorough understanding of claimed subject matter. However, it will be understood by those skilled in the art that claimed subject matter may be practiced without these specific details. Stated differently, the system and method of the present invention may facilitate seamlessly and simultaneously wirelessly powering, charging and operating portable chargeable/rechargeable devices using at least one of custom-designed and retro-designed structural architectural elements, and surfaces thereof, based on one or more wireless power transfer (or wireless charging) technologies in accordance with the principles of the present invention, whilst still abiding by, and thus not deviating from the scope and spirit of the present invention. For example, and in no way limiting the scope of the invention, the wireless power transfer (or wireless charging) technologies may be at least one of 1) non-radiative coupling-based charging (or contact/near-field non-contact/contactless/proximity charging), for instance at least one of inductive, resonance, capacitive coupling and a combination thereof, 2) radiative RF-based charging (or near-field contact/proximity/vicinity/mid-field/far-field non-contact/contactless charging), for instance at least one of directive RF power beam forming, non-directive RF radiation and a combination thereof, and a combination thereof. In other instances, methods, apparatuses or systems that would be known by one of ordinary skill have not been described in detail so as not to obscure claimed subject matter.

In some embodiments, a system for simultaneously wirelessly charging portable chargeable/rechargeable devices, using custom designed at least one of wall integrable and mountable electric switch and socket assembly, whilst facilitating at least one of hands-free (hands-off) and hands-on (hands-engaged) operation of the portable rechargeable devices and interaction therewith, and methods therefor are disclosed, in accordance with the principles of the present invention.

Embodiments of the present invention specifically relate to a system for simultaneously wirelessly charging portable rechargeable devices and facilitating hands-free operation therewith. The system comprises at least one of a wall mountable and integrable electric switch and socket assembly, wherein the assembly comprises a rear panel comprising at least one of a switch socket outlet and display, a front panel comprising a wireless charging unit with free positioning capability and improved coil and shield structure and a structurally adaptable coupling member for coupling the front panel to the rear panel, at least a portable computing and communications device removably positioned on the wireless charging unit and a wireless speaker subsystem, wherein the display is wirelessly coupled to the portable computing and communications device.

In some embodiments, the system may facilitate at least one of hands-free (hands-off) and hands-on (hands-engaged) operation of the portable computing and communications devices, and interaction therewith, correspondingly via performance of at least one of hand-initiated touch actions on, or using, 1) a universal remote control therefor and 2) one or more touch sensitive secondary multiple corresponding displays therefor, for instance one or more second screen devices, and 1) integrated touch sensitive displays of the portable computing and communications devices and 2) other input devices coupled thereto, in that order, whilst the portable computing and communications devices may be still subjected to simultaneous wireless charging. In some scenarios involving hands-free (hands-off) operation of the portable computing and communications devices, the system may facilitate performance of one or more hands-free (hands-off) tasks on the portable computing and communications devices in at least one of remote-controlled and touch-sensitive mode, such as viewing, attending or responding to incoming calls, making outgoing calls, accessing, reading and responding to incoming messages, creating or writing and sending outgoing messages, accessing, retrieving, and executing (implementing, viewing and listening) mobile applications, multimedia files and the like.

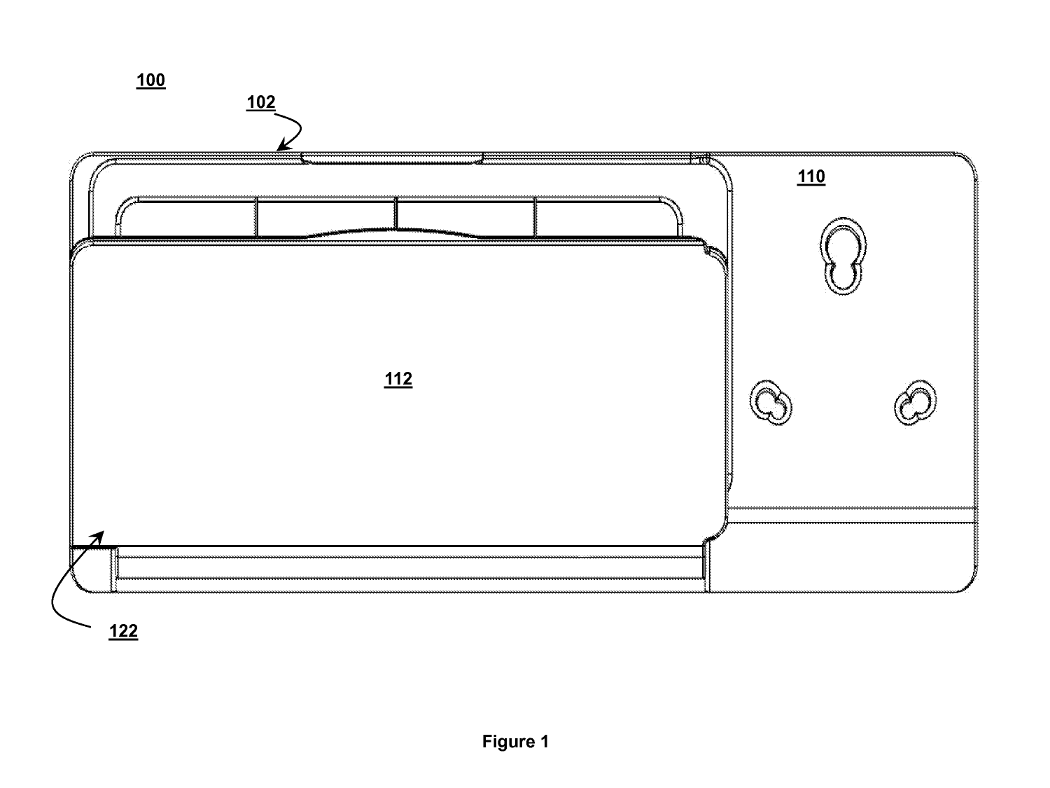

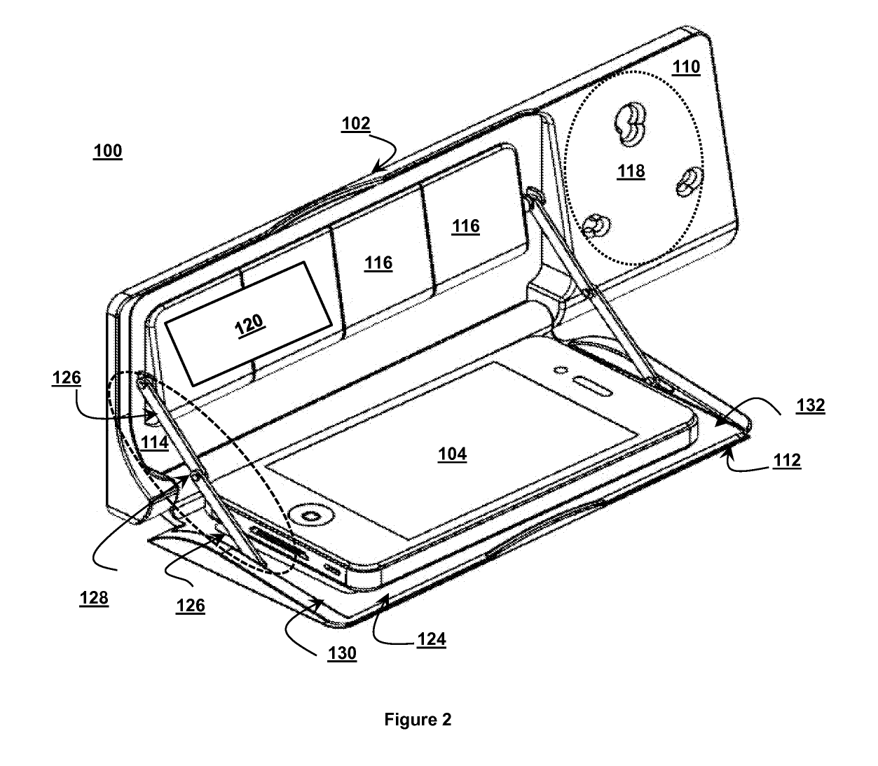

FIG. 1 depicts a perspective view of the system for wirelessly charging a portable rechargeable device whilst facilitating hands-free operation of the portable rechargeable device and interaction therewith using custom designed at least one of wall integrable and mountable electric switch and socket assembly, according to one or more embodiments.

As depicted in FIG. 1, in some embodiments, the system 100 may comprise at least one of a wall mountable and integrable electric switch and socket assembly 102, one or more portable computing and communications devices 104 (not shown here explicitly), one or more portable I/O devices 106 (not shown here explicitly) and one or more wireless networks 108 (not shown here explicitly).

The at least one of wall mountable and integrable electric switch and socket assembly 102 may comprise a rear panel 110, front panel 112, collapsible or foldable coupling member 114 (not shown here explicitly).

In some scenarios involving installation and deployment of the wall mountable electric switch and socket assembly, the rear panel may be externally, fixedly removably coupled to a wall.

FIG. 2 depicts a snapshot of the wall mountable electric switch and socket assembly in which the rear panel is externally, fixedly removably coupled to a wall and in which the front panel is in fully open or folded out state, according to one or more embodiments.

In some scenarios involving installation and deployment of the wall integrable electric switch and socket assembly, the rear panel may be at least one of partially internally and partially externally, fixedly removably coupled to a wall.

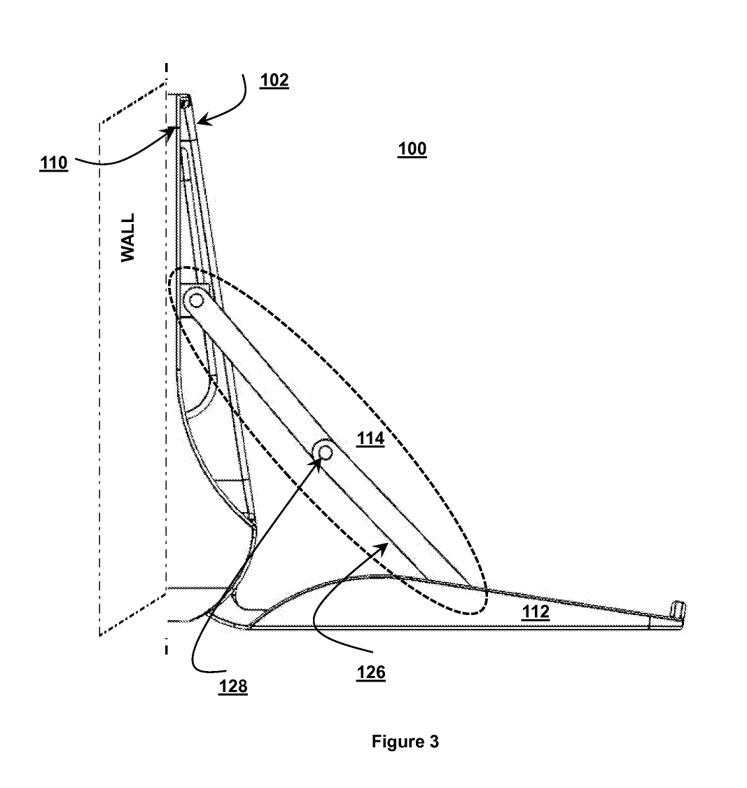

FIG. 3 depicts the wall integrable electric switch and socket assembly in which the rear panel is at least one of partially internally and partially externally, fixedly removably coupled to a wall, according to one or more embodiments.

As depicted in FIG. 2, in some embodiments, the rear panel 110 may comprise one or more electrical switches 116, one or more electric sockets 118, a display 120 and a combination thereof.

In some embodiments, the rear panel 110 may only include the display 120. For example, and in no way limiting the scope of the invention, the display 120 may be a second screen display. Specifically, for example, and in no way limiting the scope of the invention, the display type of the display 120 may be at least one of Light-Emitting Diode Display (LED), Electroluminescent Display (ELD), Plasma Display Panel (PDP), Liquid Crystal Display (LCD), such as High-Performance Addressing (HPA) display and Thin-Film Transistor (TFT) display and Organic Light-Emitting Diode (OLED) display.

As depicted in FIGS. 1-2, the front panel 112 may comprise an external front surface 122 and an internal rear surface 124.

As depicted in FIG. 2, the front panel 112 may be collapsibly or foldably coupled to the rear panel 110 through the collapsible or foldable coupling member 114. Specifically, the front panel 112 may be orthogonally rotatably coupled to the rear panel 110 through the collapsible or foldable coupling member 114. As a consequence, in operation, the front panel 112 may be capable of rotating clockwise orthogonally relative to the rear panel 110. In some scenarios, the front panel 112 may reach a maximum possible distance, or achieve a maximum angular displacement, away from the rear panel 110 such that the front panel 112 subtends an angle of approximately 90° degrees relative to the surface of the rear panel 110.

In some embodiments, as depicted in FIGS. 2-3, the collapsible or foldable member 114 may comprise a pair of sub-members 126 with homogeneous specifications and a pivotal joint member 128.

As depicted in FIG. 2, the internal rear surface 124 may comprise a receptacle tray 130 and wireless charging unit 132 (not shown here explicitly) positioned thereupon.

In some embodiments, the wireless charging unit 132 may be fixedly removably coupled to the receptacle tray 130.

In operation, the wireless charging unit 132, of the receptacle tray 130, may facilitate wirelessly charging the portable computing and communications device 104 via positioning of the same on the wireless charging unit 132, by a user.

The portable computing and communications device 104 (not shown here explicitly) may comprise of a microcomputer unit 134. The microcomputer unit 134 may comprise of a microprocessor sub-unit 136, memory sub-unit 138, an I/O sub-unit 140 and a set of support circuits 142.

The I/O unit 134 comprises one or more I/O ports for wireless communication. For example, and in no way limiting the scope of the invention, the I/O ports may comprise at least an Infrared (IR) port, a BLUETOOTH® port, Near Field Communication (NFC) port and Wi-Fi port.

In some embodiments, the display may be wirelessly coupled to the portable computing and communications device positioned upon the wireless charging unit. For example, and in no way limiting the scope of the invention, the display may be wirelessly communicably and operably coupled to the portable computing and communications device, positioned upon the wireless charging unit, via at least one of BLUETOOTH®, Infrared (IR) and Wi-Fi network connection.

In some embodiments, the display 120 may be at least one of a remote-controlled and touch-sensitive display.

In some scenarios, in operation, the remote-controlled display 120 may facilitate remote management thereof, i.e. operation and control of the remote-controlled display 120 as well as interaction therewith, via usage of a remote control therefor by the user, thereby facilitating managing the portable computing and communications device 104 wirelessly communicably and operably coupled to the remote-controlled display 120.

In some scenarios, in operation, the touch-sensitive display 120 may facilitate close management thereof, i.e. operation and control of the touch-sensitive display 116 as well as interaction therewith, via performance of touch actions thereupon by the user, thereby facilitating managing the portable computing and communications device 104 wirelessly communicably and operably coupled to the touch-sensitive display 120.

In some scenarios involving deployment and implementation of the system, in entirety, the system may facilitate wirelessly charging the portable computing and communication device, using the custom designed at least one of wall integrable and mountable electric switch and socket assembly, whilst facilitating hands-free operation of the portable rechargeable device, and interaction therewith. In some scenarios, the system may facilitate at least one of hands-free (hands-off) and hands-on (hands-engaged) operation of the portable computing and communications devices, and interaction therewith, correspondingly via performance of at least one of hand-initiated touch actions on, or using, 1) a universal remote control therefor and 2) one or more touch sensitive secondary multiple corresponding displays therefor, for instance one or more second screen devices, and 1) integrated touch sensitive displays of the portable computing and communications devices and 2) other input devices coupled thereto, in that order, whilst the portable computing and communications devices may be still subjected to simultaneous wireless charging. In some scenarios involving hands-free (hands-off) operation of the portable computing and communications devices, the system may facilitate performance of one or more hands-free (hands-off) tasks on the portable computing and communications devices in at least one of remote-controlled and touch-sensitive mode, such as viewing, attending or responding to incoming calls, making outgoing calls, accessing, reading and responding to incoming messages, creating or writing and sending outgoing messages, accessing, retrieving, and executing (implementing, viewing and listening) mobile applications, multimedia files and the like.

In some embodiments, the system 100 may comprise a wireless speaker subsystem 144 (not shown here explicitly).

The wireless speaker subsystem 144 may comprise a combined wireless speaker-Radio Frequency (RF) receiver unit 146 and a RF transmitter unit 148.

In operation, the wireless speaker subsystem 144 may receive audio signals using Radio Frequency (RF) waves rather than over audio cables.

Specifically, in use, the RF transmitter unit 148 may be coupled to the audio output of the portable computing and communications device 104 via a RCA plug. The combined wireless speaker-Radio Frequency (RF) receiver unit 146 is positioned as per the user requirements, thereby providing the freedom to move around without the need of using cables. Both the combined wireless speaker-Radio Frequency (RF) receiver unit 146 and RF transmitter unit 148 comprise an amplifier to boost the audio signal to the combined wireless speaker-Radio Frequency (RF) receiver unit 146, which may be powered by at least one of batteries and an AC electric outlet. For example, and in no way limiting the scope of the invention, the batteries may be at least one of wiredly and wirelessly rechargeable.

In some embodiments, the wireless speaker subsystem 144 may possess apt specifications, in accordance with the principles of the present invention. For example, and in no way limiting the scope of the invention, the wireless speaker subsystem 144 may possess the following specifications: 1) the signal frequency range may be the same as used by cordless telephones, i.e. approximately 900 MHz; 2) the type may be stereo speaker, and the like. Thus, in use, the RF signal may traverse walls and floors/ceilings. In some scenarios, in use, the RF signal may be transmitted over a range varying from a minimum of approximately 150 feet to a maximum of approximately 300 feet. In some scenarios involving the wireless speaker subsystem 144 featuring variable transmission channels, the variable transmission channels may be set using a tuning knob to overcome potential RF interference with other nearby wireless devices, such as cordless phones or baby monitors. In some scenarios involving deployment of BLUETOOTH® devices, the BLUETOOTH® devices may use a radio communications system, and therefore may not have to be in a visual line of sight with each other.

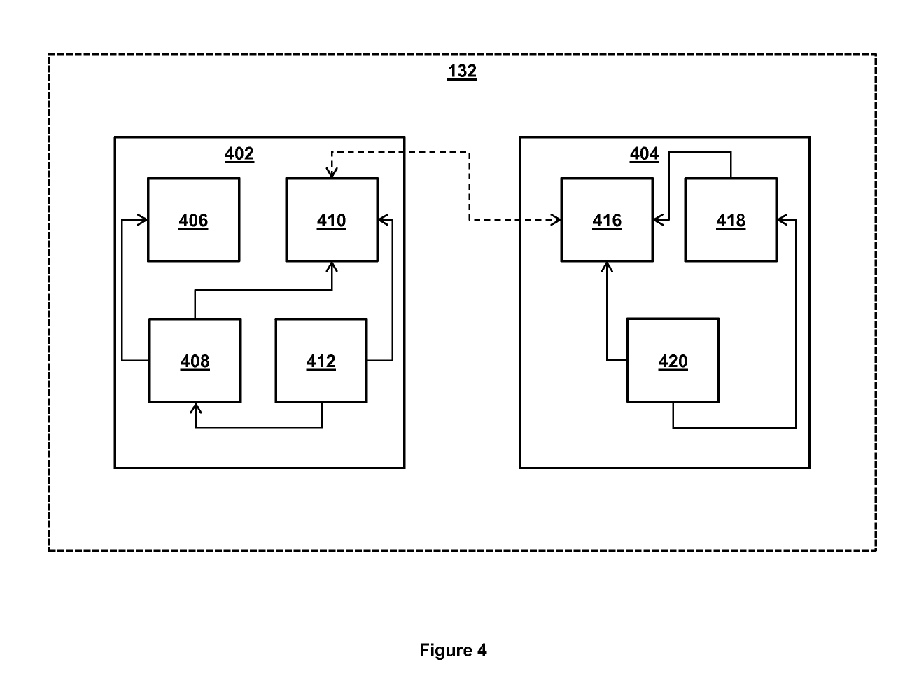

FIG. 4 depicts a detailed block diagram of the wireless charging unit 132, of FIG. 1, for optionally simultaneously wirelessly charging portable chargeable/rechargeable devices using wireless inductive power transfer with seamless free positioning capability and improved shield structure, according to one or more embodiments.

The wireless charging unit 132 may comprise a charging subunit 402 and one or more portable chargeable devices 404. For purposes of clarity and expediency, the wireless charging unit 132 may be hereinafter referred to as an Adaptive Position Free (APF) wireless charging unit.

In some embodiments, each of the portable chargeable devices 404 may be at least one of a portable computing device, portable communications device and a combination thereof, for instance a portable computing and communications device.

In some embodiments, each of the portable computing devices may be at least one of a portable computer, tablet computer, Personal Digital Assistant (PDA), an ultra mobile PC, a smart phone, carputer, portable communications, pentop computer, wearable computer, such as a smart watch, and the like. Likewise, in some embodiments, each of the portable communications devices may be at least one of a mobile device, and the like.

The charging subunit 402 may comprise a shield 406, at least a first controller 408, a transmitter coil array 410 and a first power source 412.

For purposes of clarity and expediency, the charging subunit 402 may be hereinafter interchangeably referred to as at least one of a base station and power transmitter.

Specifically, in use, the charging subunit 402 may facilitate simultaneously wirelessly charging portable chargeable/rechargeable devices 404 using wireless inductive power transfer with streamlined and seamless, free positioning capability.

In some embodiments, for example, and in no way limiting the scope of the invention, the shield 406 may be at least one of an electric, a magnetic and an electromagnetic shield.

In some embodiments, the shield employed may be at least one of a composite (or compact) modular and single shield, designed in accordance with the principles of the present invention. Specifically, the composite modular shield may comprise one or more sets of shield blocks (i.e. sets of one or more individual modular shield blocks) thereby facilitating realization or formation of at least one of asymmetric and symmetric shielding zones, wherein each of the sets of shield blocks may comprise one or more individual modular shield blocks possessing homogeneous specifications, for instance material, constructional, dimensional, geometrical, spatial position and orientation specifications therefor.

In some embodiments involving isolation from external magnetic fields, use of a magnetic shield is disclosed, in accordance with the principles of the present invention. For example, in some scenarios involving static or slowly varying magnetic fields below approximately 100 kHz, the Faraday shielding may be ineffective. Thus, shields made of metal alloys with high magnetic permeability may be used, such as sheets of Permalloy and Mu-Metal, or ferromagnetic metal coatings with nano-crystalline grain structure. In use, the aforementioned materials may not block the magnetic field, as with electric shielding; rather draw the magnetic field into the aforementioned materials, thereby facilitating providing a path for the magnetic field lines around the shielded volume. In some scenarios, the best shape for magnetic shields may thus be a closed container surrounding the shielded volume. The effectiveness of the magnetic shielding depends on the permeability of the material, which generally drops off at both very low magnetic field strengths and at high field strengths, wherein the material may become saturated. In order to achieve low residual fields, the magnetic shields may often consist of several enclosures one inside the other, each of which successively reduces the field therein. In some scenarios, in use, a magnetic shield, for instance the shield 106, may facilitate maximizing the power transfer efficiency via directing the flux paths.

In some scenarios, in use, an electromagnetic shield, for instance the shield 406, may facilitate reducing the electromagnetic field by blocking the electromagnetic field. For example, and in no way limiting the scope of the invention, the electromagnetic shield 406 may be made of at least one of conductive and magnetic materials. For instance, in some embodiments, the electromagnetic shield 406 may be made of at least one of a sheet metal, metal screen, metal foam and a combination thereof.

The amount of reduction of the electromagnetic field resulting from the electromagnetic shield 406 may depend on one or more factors, namely 1) the material, and the thickness therefor, 2) the size of the shielded spatial volume and 3) the frequency of the fields of interest and 4) the size, shape and orientation of apertures in the shield to an incident electromagnetic field.

The transmitter coil array 410 may facilitate generation of electromagnetic field. The transmitter coil array 410 may comprise one or more transmitter coils (not shown here explicitly). In some embodiments, for example, and in no way limiting the scope of the invention, the transmitter coil array 410 may include six (6) transmitter coils.

In some embodiments, at least one of the charging subunit 402 and components thereof may be at least one of partially and fully disposed in a first housing element 414 (not shown here explicitly).

The first controller 108 may be coupled to the transmitter coil array 410 and first power source 412.

In some embodiments, the first controller 408 may be in essence a programmable microcontroller.

In operation, the first controller 408 may facilitate managing the operations of the one or more transmitter coils of the transmitter coil array 410.

Each of the portable chargeable devices 404 may comprise a receiver coil 416, a second controller 418 and a second power source 420.

The second controller 418 may be coupled to the receiver coil 416 and second power source 420. The second controller 418 may be in essence a programmable microcontroller.

In some embodiments, at least one of the portable chargeable devices 104 and components thereof may be at least one of partially and fully disposed in a second housing element 422 (not shown here explicitly).

However, in other embodiments, the components of the charging subunit 402 and the portable chargeable devices 404 may be modified and coupled together differently in any suitable manner without departing from the spirit and scope of the present invention.

In operation, power may be transmitted or transferred wirelessly between the transmitter coil array 410 and one or more receiver coils 416 via wireless power coupling. In typical settings for charging small mobile devices, e.g., cell phones, smart phones, PDAs, music players, sound recorders, portable gaming consoles, wireless headsets, GPS devices, etc., the wireless power coupling is a known inductive coupling.

Each of the transmitter coils in the transmitter coil array 410 may facilitate generating an electromagnetic field upon application or supply of power thereto using the first power source 412. The generated electromagnetic field may facilitate inducing a power flow in the receiver coil 416 upon proper alignment of the receiver coil 416 in the generated electromagnetic field. The power flow in the receiver coil 416 may be used to power the portable computing and communications device 404 and/or recharge the second power source 420. The configuration of each of the transmitter coils in the transmitter coil array 410 and at least one receiver coil 416, e.g., the number of turns of the coils around a core, the composition of the core, the composition of the coils (including wire gauge), the dimensions of the core and coils, etc., may be designed to provide an efficient wireless power transfer between the primary and secondary coils, as would be apparent to one of skill in the art.

The first controller 408 of the charging subunit 402 may be configured to control the operation of the portable computing and communications device 404. For example, by controlling the voltage and/or current supplied from the first power source 412 to the transmitter coil array 410 so that the electromagnetic field generated by the transmitter coil array 410 may efficiently induce appropriate voltage and current waveforms in the receiver coil 416 of the portable computing and communications device 404. In some embodiments, the voltage and/or current supplied to the transmitter coil array 410 may be controlled by other known power conditioning/regulating components. Similarly, the second controller 418 of the portable computing and communications device 404 may be configured to control the operation of the portable computing and communications device 404. For example, by regulating and/or converting the voltage and/or current received by the receiver coil 116 to provide appropriate power levels to charge the second power source 420, and other components of the portable computing and communications device 404.

In operation, in some scenarios, the first controller 408 may facilitate sequentially scanning each of the transmitter coils in the transmitter coil array 410. Upon detection of the presence of the receiver coils 416 of the one or more portable chargeable devices 404 on the charging subsystem 402 positioned at one or more positions relative to the transmitter coils, the first controller 408 may facilitate at least one of selectively activating and deactivating the transmitter coils thereby facilitating minimization of cross-interference therebetween.

In some embodiments, one or more potential overall physical configurations in connection with the charging subsystem are disclosed, in accordance with the principles of the present invention. Specifically, the overall physical configuration in connection with the charging subsystem comprises material, constructional, dimensional, geometrical, spatial position and orientation specifications regarding the charging subsystem, and transmitter coil array thereof. In some embodiments, the charging subsystem and transmitter coil array thereof possess apposite material, constructional, dimensional, geometrical, spatial position and orientation specifications, designed in accordance with the principles of the present invention.

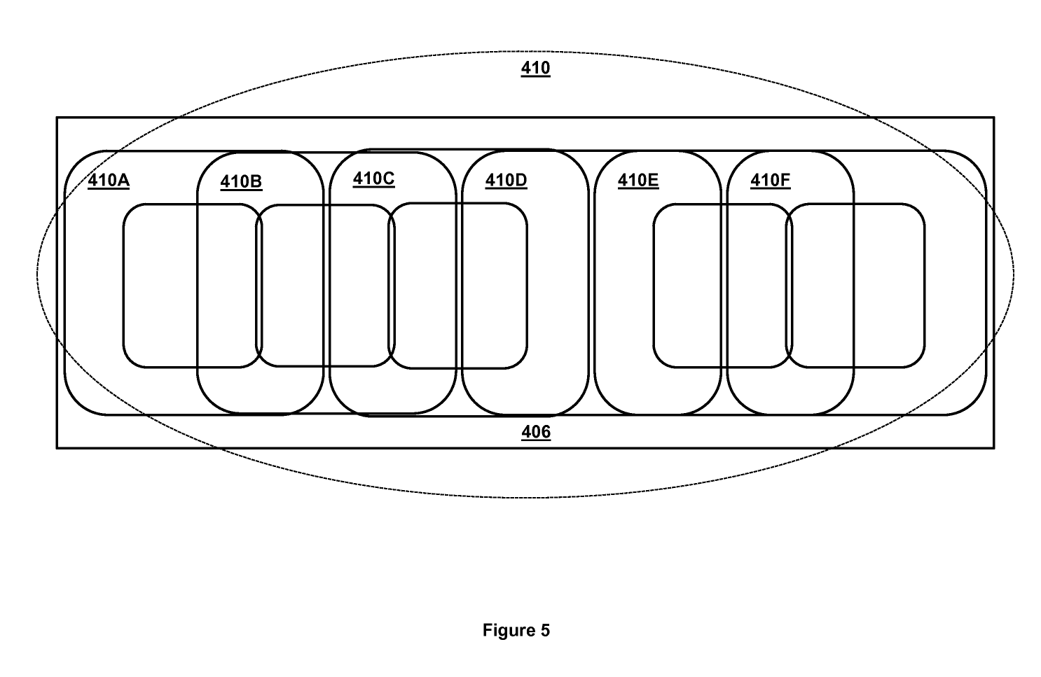

FIG. 5 depicts an exemplary potential overall physical configuration in connection with the charging subunit 402, and transmitter coil array 410 thereof, of FIG. 4, in accordance with one or more embodiments.

As depicted in FIG. 5, the transmitter coil array 410 may comprise one or more transmitter coils. In some embodiments, for example, and in no way limiting the scope of the invention, the transmitter coil array 410 may include six (6) transmitter coils. For purposes of clarity and expediency, the transmitter coil array 410 including the six (6) transmitter coils may be divided into two sub-arrays, namely odd and even numbered transmitter coils. Specifically, the odd numbered transmitter coils may include three (3) transmitter coils that have been hereinafter referred to as a first transmitter coil 410A, third transmitter coil 410C and fifth transmitter coil 410E respectively. Likewise, the even numbered transmitter coils may include three (3) transmitter coils that have been hereinafter referred to as a second transmitter coil 410B, fourth transmitter coil 410D and sixth transmitter coil 410F respectively.

In some embodiments, by virtue of the overall physical configuration in connection with the charging subunit 402, and the transmitter coil array 410 thereof, the system 100 may facilitate charging of at least a pair of portable computing and communications device 104.

For example, and in no way limiting the scope of the invention, the charging subunit 402 and transmitter coil array 410 thereof may possess the following material, constructional, dimensional, geometrical, spatial position and orientation specifications, namely 1) material of the shield 406 may be ferrite; 2) optional geometry of the shield 406 may be three-dimensional (3D) solid rectangular cuboid with or without rounded corners; 3) length, breadth and height, i.e. dimensions, of the shield 406 may be approximately 84 mm*160 mm*10 mm; 4) length and breadth, i.e. dimensions, of each of the transmitter coils in the transmitter coil array 410 may be approximately 45 mm*52 mm; 5) number of the transmitter coils in the transmitter coil array 410 may be 6; 6) optional geometry of each of the transmitter coils in the transmitter coil array 410 may be three-dimensional (3D) hollow rectangular lamina with rounded corners; 7) relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and may be positioned immediately beneath each of the even numbered transmitter coils; 8) relative inter-coil spatial positioning of the odd numbered transmitter coils may be such that the first 410A, third 410C and fifth 410E transmitter coils in that order may be juxtaposed in close vicinity to each other in a continuous linear fashion; 9) relative inter-coil spatial positioning of the even numbered transmitter coils may be such that the second 410B, fourth 410D and sixth 410F transmitter coils in that order may be proximately juxtaposed to each other in a continuous linear fashion; 10) relative inter-coil spatial positioning of both even and odd numbered transmitter coils may be such that each of the even numbered transmitter coils may partially overlap with a pair of immediately preceding and proceeding odd numbered transmitter coils; 11) inter transmitter coil array edge and the shield 406 length spacing may be less than approximately 5 mm; 12) inter transmitter coil array edge and the shield 406 breadth spacing may be approximately 5 mm.

In some best case scenarios, in operation, each of the six (6) transmitter coils, namely first 410A, second 410B, third 410C, fourth 410D, fifth 410E and sixth 410F, may be continuously sequentially scanned.

Advantageously, in some worst case scenarios involving random positioning of a single portable chargeable device 404 on the charging subunit 402, the overall physical configuration in connection with the charging subunit 402 and transmitter coil array 410 thereof may provide necessary and sufficient (or optimal) alignment between the receiver 416 and each of the transmitter coils 410A-F in the transmitter coil array 410. For example, and by no way of limitation, at least a minimum of approximately 70% alignment may be achieved between the receiver coil 416 and each of the transmitter coils 410A-F in the transmitter coil array 410 in case a single portable computing and communications device 404 may be positioned on at least one of the top-left and bottom-right corners of the charging subsystem 402.

In some embodiments, the system may facilitate streamlined and seamless free positioning of one or more portable chargeable devices manually on the charging subsystem thereby eliminating the need for guided or selective positioning.

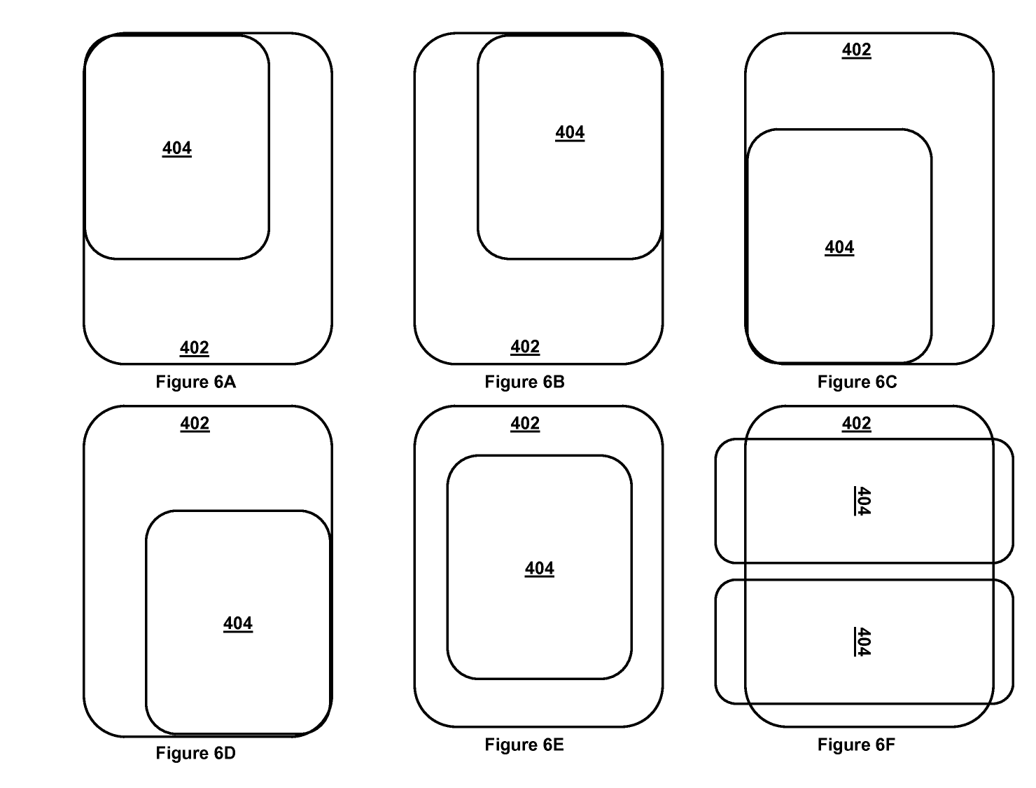

FIGS. 6A-F depicts an assortment of possibilities, and corresponding use case scenarios, in connection with the positioning of the portable chargeable devices 404 relative to the charging subunit 402, of FIG. 4, in accordance with one or more embodiments.

As depicted in FIG. 6A, in some use case scenarios, the system 100, of FIG. 1, may facilitate manual positioning of the portable computing and communication device 404 at a top-left position relative to the charging subunit 402 by a user.

As depicted in FIG. 6B, in some use case scenarios, the system 100, of FIG. 1, may facilitate manual positioning of the portable computing and communication device 404, of FIG. 4, at a top-right position relative to the charging subunit 402, of FIG. 4, by a user.

As depicted in FIG. 6C, in some use case scenarios, the system 100 may facilitate manual positioning of the portable computing and communication device 404 at a bottom-left position relative to the charging subsystem by a user.

As depicted in FIG. 6D, in some use case scenarios, the system 100 may facilitate manual positioning of the portable computing and communication device 404 at a bottom-right position relative to the charging subsystem by a user.

As depicted in FIG. 6E, in some use case scenarios, the system 100 may facilitate manual positioning of the portable computing and communication device 404 at a central position relative to the charging subsystem by a user.

As depicted in FIG. 6F, in some use case scenarios, the system 100 may facilitate manual positioning of at least a pair of portable computing and communication devices 404 at central positions relative to the charging subsystem by a user, wherein the pair of the portable computing and communication devices 404 are juxtaposed in at least one of proximity and vicinity of each other.

In some embodiments, adaptive free positioning capability of the system by virtue of the overall physical configuration of the charging subsystem, and transmitter coil array thereof, as well as selective activation and deactivation of the transmitter coils constituting the transmitter coil array is disclosed, in accordance with the principles of the present invention.

In some scenarios, the system 100, of FIG. 1, may facilitate charging at least one portable computing and communications device 104 and at least a pair of additional portable computing and communication devices 104 using the free positioning capability, wherein the pair of additional devices 104 may be centrally positioned relative to the charging subunit 402, of FIG. 4, and wherein the pair of additional devices 104 may be juxtaposed in at least one of proximity and vicinity of each other. Thus, there may be a likelihood or probability of occurrence of one or more events, such as at least one of power transfer and communications events, at least one of simultaneously and separately, owing to at least a pair of transmitter coils constituting the transmitter coil array 410, of FIG. 4, in any point in time.

Reiterating again with reference to FIG. 4, the magnetic shield 406 may facilitate maximizing the power transfer efficiency via directing the flux paths. However, as a consequence, the magnetic shield 406 may facilitate providing for a common impedance path thereby resulting in cross-interference amid two or more transmitter coils, constituting the transmitter coil array 410, juxtaposed in at least one of proximity and vicinity of each other.

In some embodiments, introduction of a gap in the shield facilitates elimination of cross-interference amid two or more transmitter coils. However, the introduction of the gap may have an impact on the efficiency of power transfer, and thus there has to be a trade-off between introduction of the gap and corresponding impact on the efficiency of power transfer.

In some embodiments, a method for selectively activating and deactivating one or more transmitter coils constituting the transmitter coil array is disclosed, in accordance with one or more embodiments. Specifically, the method facilitates achievement of efficient power transfer and reliable communications between the transmitter and receiver coils despite the presence of the common impedance path introduced by the shield leading to cross-interference amid two or more transmitter coils.

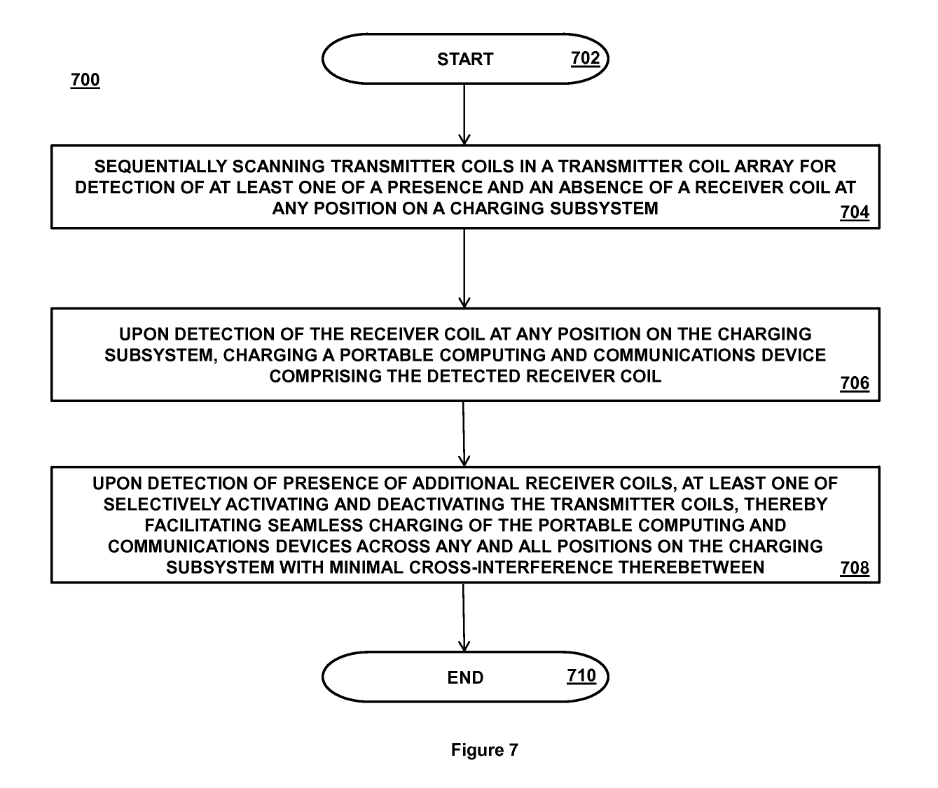

FIG. 7 depicts a flow diagram for a method for at least one of selectively activating and deactivating one or more transmitter coils constituting the transmitter coil array, in accordance with one or more embodiments.

The method 700 may start at step 702 and may proceed to step 704. In some embodiments, for example, and in no way limiting the scope of the invention, the method 700 may be implemented by a controller, for instance the first controller 408, of FIG. 4.

At step 704, the method 700 may facilitate, or comprise, sequentially scanning one or more transmitter coils in a transmitter coil array for detection of at least one of a presence and an absence of a receiver coil at any position on a charging subsystem, for instance the charging subunit 402 of FIG. 4. In some embodiments, for example, and in no way limiting the scope of the invention, each transmitter coil of a transmitter coil array, for instance each of the transmitter coils 410A-F of the transmitter coil array 410 of FIGS. 4-5, may be sequentially scanned for detection of at least one of presence and absence of a receiver coil, for instance the receiver coil 416, at any position on the charging subunit 402.

In some scenarios involving detection of at least one of presence and absence of any portable computing and communications device, the receiver coil thereof may be detected at any position on the charging subsystem. In some embodiments, for example, and in no way limiting the scope of the invention, the receiver coil 416 may be detected at any given position on the charging subunit 402.

At step 706, upon detection of the receiver coil at any position on the charging subsystem, the method 700 may facilitate, or comprise, charging a portable computing and communications device comprising the detected receiver coil. In some embodiments, for example, and in no way limiting the scope of the invention, a portable computing and communications device, for instance the device 404, comprising the receiver coil 416 may be subjected to wireless charging.

In some scenarios involving deployment of the system for securely wirelessly charging a proprietary portable computing and communications device, upon detection of the receiver coil thereof at any position on the charging subsystem, the method 700 may facilitate, or further comprise, authenticating and authorizing the proprietary portable computing and communications device for purposes of charging. In some scenarios, in the event that an additional proprietary portable computing and communications device may request charging on the charging subsystem upon manual positioning of the additional device thereon, the method 700 may facilitate, or further comprise, charging the additional proprietary portable computing and communications device subsequent to successful authentication and authorization of the additional device. In some scenarios, in the event that yet another additional proprietary portable computing and communications device may request charging on the charging subsystem upon manual positioning of the device thereon, the method 700 may facilitate, or further comprise, charging the yet another additional proprietary portable computing and communications device subject to at least one of execution and non-execution of the tests for authentication and authorization.

At step 708, upon detection of presence of one or more additional receiver coils, the method 700 may facilitate, or further comprise, at least one of selectively activating and deactivating the one or more transmitter coils, thereby facilitating seamless charging of additional portable computing and communications devices comprising the additional receiver coils across any and all positions on the charging subsystem with minimal cross-interference therebetween. The method 700 may proceed to step 710 and end.

Table 1 discloses an exemplary tabular representation in connection with proprietary control logic facilitating managing interoperability of the transmitter coils constituting the transmitter coil array based at least in part on one or more potential shield structures, potential coil configurations and a combination thereof, designed and implemented in accordance with the principles of the present invention.

| | |
|---|---|
| | TRANSMITTER |
| | (TX) COILS |
| | ACTIVATION AND |
| | DEACTIVATION AND |
| | INTEROPERABILITY |
| | SCHEME |
| RECEIVER | THERE BETWEEN |
| (RX) COIL | ACTION BASED |
| DETECTED AT | TRANSMITTER (TX) |
| TRANSMITTER | COIL STATE |

| (TX) COIL | DEACTIVATED | ACTIVATED |
|---|---|---|
| 1 | 2, 3 | 4, 5, 6 |
| 2 | 1, 3, 4 | 5, 6 |
| 3 | 1, 2, 4, 5 | 6 |
| 4 | 2, 3, 5, 6 | 1 |
| 5 | 3, 4, 6 | 1, 2 |
| 6 | 4, 5 | 1, 2, 3 |

In some embodiments, implementation of the proprietary control logic facilitating managing interoperability of the transmitter coils constituting the transmitter coil array based at least in part on one or more potential shield structures, potential coil configurations and a combination thereof is disclosed, in accordance with the principles of the present invention. Specifically, the first controller may facilitate implementation of the proprietary control logic facilitating defining one or more at least one of selective activation and deactivation schemes in connection with the transmitter coils thereby facilitating managing interoperability therebetween.

In some embodiments, the first controller may be in essence a programmable microcontroller and may comprise a memory unit, microprocessor unit and an I/O unit. Specifically, the memory unit may comprise a control logic module facilitating implementation of the proprietary control logic, in turn, facilitating defining one or more of at least one of selective activation and deactivation schemes in connection with the transmitter coils, thereby facilitating managing interoperability therebetween.

Advantageously, in some embodiments, the system may facilitate simultaneous wirelessly charging at least a pair of portable chargeable devices using at least a pair of simultaneous communication channels based on wireless inductive power transfer whilst providing a common shield to maximize power transfer efficiency and facilitating at least one of selectively activating and deactivating transmitter coils to minimize cross-interference therebetween with seamless free positioning capability.

Still advantageously, in some embodiments, the system may facilitate charging of at least one of previous, current and future versions of Wireless Power Consortium (WPC)s′-QI compatible phones and receivers therefor in contrast to WPC's only promise for backward compatibility.

Still further advantageously, in some embodiments, the system may facilitate charging of at least one of previous, current and future versions of Power Matters Alliance (PMA) or ALLIANCE FOR WIRELESS POWER®-compatible phones and receivers therefor.

Yet, in other advantageous embodiments, the system may facilitate streamlined and seamless concurrent charging of multiple portable chargeable WPC-compatible devices with free positioning capability and both backward and forward compatibility therefor, in contrast to other technologies with a relatively higher level of engineering approach that may not be commercially viable in near future, and may also require increased cost on both transmitter and receiver side to be compatible with existing solutions.

In some embodiments, one or more potential overall physical configurations in connection with the charging subsystem, and transmitter coil array thereof, thereby facilitating at least one of zeroization and minimization of Electromagnetic Field (EMF), thermal and interference losses, whilst maximization of efficiency, are disclosed in accordance with the principles of the invention. In some specific embodiments, the shield may be custom-designed, in accordance with the principles of the present invention. Specifically, the shield may possess at least one of composite modular and monolithic design.

In some embodiments, the shield may comprise one or more sets of shield blocks thereby facilitating definition of asymmetric zones thereupon, wherein each of the sets of shield blocks may possess homogeneous specifications, for instance material, constructional, dimensional, geometrical, spatial position and orientation specifications therefor.

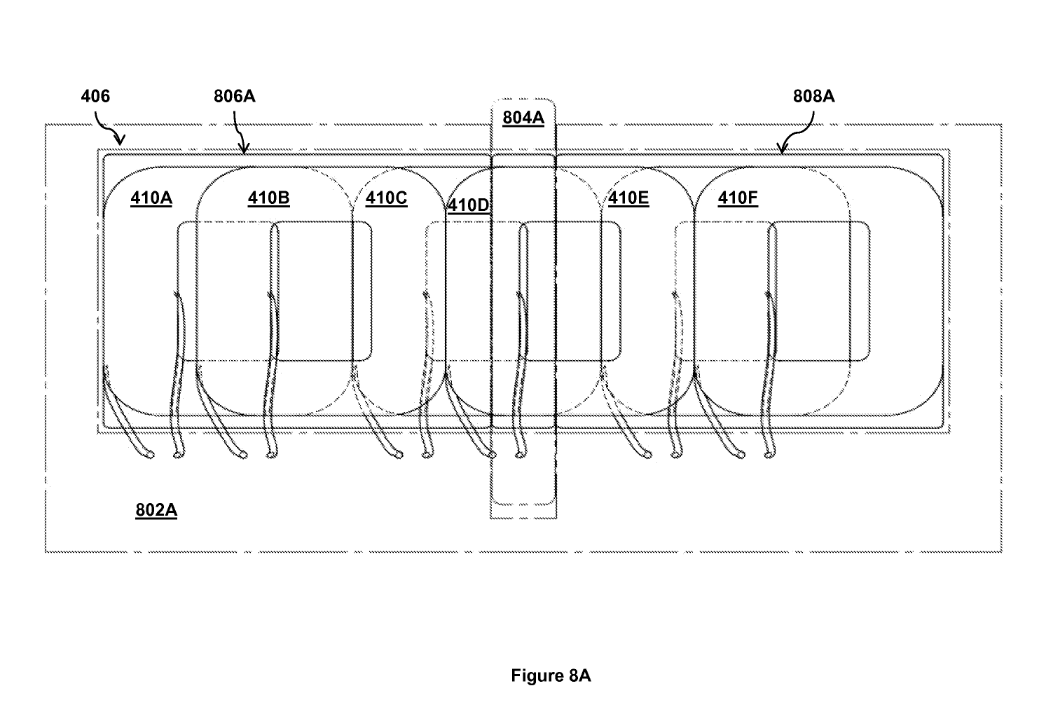

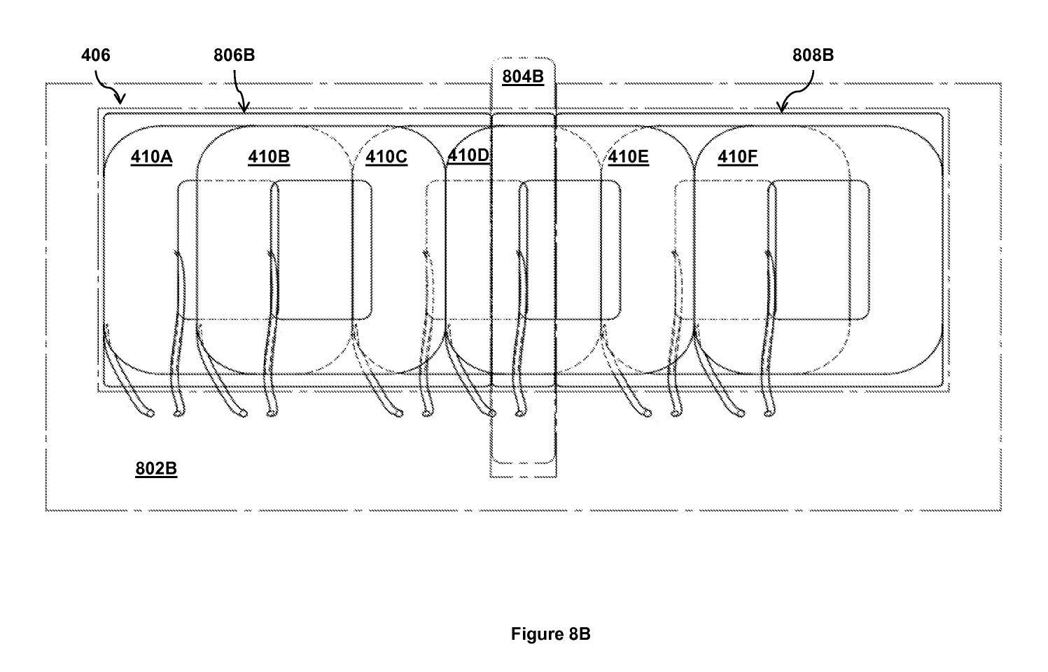

FIG. 8A depicts an exemplary second potential overall physical configuration in connection with the charging subunit 402, and transmitter coil array 410 thereof, of FIG. 4, in accordance with one or more embodiments.

As depicted in FIG. 8A, the shield 406, of FIG. 4, may possess a composite modular design. For example, and in no way limiting the scope of the invention, the shield 406 may include at least two heterogeneous sets of shield blocks, wherein each shield block in each set of the two heterogeneous sets of shield blocks may possess homogeneous specifications, for instance material, constructional, dimensional, geometrical, spatial position and orientation specifications therefor. For purposes of clarity and expediency, the two heterogeneous sets of shield blocks may be hereinafter referred to as a first and set of shield blocks 802A and 804A. For example, and in no way limiting the scope of the invention, the first set of shield blocks 802A may include a pair of shield blocks, namely a first and second shield blocks 806A and 808A, with homogeneous specifications, for instance material, constructional, dimensional, geometrical, spatial position and orientation specifications therefor. Likewise, for example, and in no way limiting the scope of the invention, the second set of shield blocks 804A may include a single shield block, namely a third shield block 810A with distinct specifications.

As depicted in FIG. 8A, for example, and in no way limiting the scope of the invention, in accordance with the second potential overall physical configuration the charging subunit 402, and transmitter coil array 410 thereof, of FIG. 4, may possess the following material, constructional, dimensional, geometrical, spatial position and orientation specifications, namely:

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >55 mm*>145.10 mm*>=1 mm;

4) the spatial position and orientation of the heat sink metallic plate relative to the shield 406 may be such that the heat sink metallic plate may be juxtaposed beneath the shield 406 and coupled therewith;

5) the material of the shield 406 may be ferrite;

6) the constructional design or structure of the shield 406 may be composite modular type;

7) the total number of shield blocks 806A, 808A and 810A constituting the shield 106 may be 3;

8) the relative spatial positioning of each of the shield blocks 806A, 808A and 510A may be such that each of the shield blocks 806A, 808A and 810A may be proximally juxtaposed to each other without any slit or gap therebetween;

9) the optional geometry of each of the shield blocks 806A, 808A and 810A of the shield 406 may be a thin (or laminar) three-dimensional (3D) solid rectangular cuboid with or without rounded corners;

10) the length, breadth and height, i.e. dimensions, of the each of the shield blocks of the pair of shield blocks 806A and 808A of the shield 406 may be approximately 55 mm*67.05 mm*1 mm;

11) the length, breadth and height, i.e. dimensions, of the shield block 810A of the shield 406 may be approximately 55 mm*11 mm*0.7 mm;

12) the length and breadth, i.e. dimensions, of each of the transmitter coils in the transmitter coil array 410 may be approximately 43 mm*50 mm;

13) the total number of transmitter coils in the transmitter coil array 410 may be 6;

14) the optional geometry of each of the transmitter coils in the transmitter coil array 410 may be a thin three-dimensional (3D) hollow rectangular ring with rounded corners;

15) the relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and may be positioned immediately beneath each of the even numbered transmitter coils;

16) the relative inter-coil spatial positioning of the odd numbered transmitter coils may be such that the first 410A, third 410C and fifth 410E transmitter coils in that order may be juxtaposed in close vicinity to each other in a continuous linear fashion;

17) the relative inter-coil spatial positioning of the even numbered transmitter coils may be such that the second 410B, fourth 410D and sixth 410F transmitter coils in that order may be proximately juxtaposed to each other in a continuous linear fashion;

18) the relative inter-coil spatial positioning of both even and odd numbered transmitter coils may be such that each of the even numbered transmitter coils may partially overlap with a pair of immediately preceding and proceeding odd numbered transmitter coils;

19) the total inter transmitter coil array 410 and the shield 406 length-wise edge spacing may be approximately 5 mm, i.e. the total lengthwise spacing between the edges of the transmitter coil array 410 and the edges of the shield 106 may preferably be approximately 5 mm, for instance most preferably 5 mm;

20) the total inter transmitter coil array 410 and the shield 406 breadth-wise edge spacing may be approximately 0 mm, i.e. the total breadth-wise spacing between the edges of the transmitter coil array 410 and the edges of the shield 406 may be approximately 0 mm;

21) the inter external proximal edge distance between the first and second transmitter coils 410A and 410B, i.e. the distance between the outer proximal edges of the first and second transmitter coils 410A and 410B, may be approximately 16.10 mm;

22) the distance between the inner distal edge of the second transmitter coil 410B and the inner proximal edge of the third transmitter coil 410C is approximately 9.5 mm; and

23) the distance between the inner distal edge of the fourth transmitter coil 410D and the inner proximal edge of the fifth transmitter coil 410E may be approximately 9.5 mm.

FIG. 8B depicts a third potential overall physical configuration in connection with the charging subunit 402, and transmitter coil array 410 thereof, of FIG. 4, in accordance with one or more embodiments.

As depicted in FIG. 8B, the shield 406 may possess a composite modular design. For example, and in no way limiting the scope of the invention, the shield 406 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and set of shield blocks 802B and 804B. For example, and in no way limiting the scope of the invention, the first set of shield blocks 802B may include a pair of shield blocks, namely a first and second shield blocks 806B and 808B, with homogeneous specifications, for instance material, constructional, dimensional, geometrical, spatial position and orientation specifications therefor. Likewise, for example, and in no way limiting the scope of the invention, the second set of shield blocks 804B may include a single shield block, namely a third shield block 810B with distinct specifications.

As depicted in FIG. 8B, for example, and in no way limiting the scope of the invention, in accordance with the third potential overall physical configuration the charging subunit 402, and transmitter coil array 410 thereof, may possess the following material, constructional, dimensional, geometrical, spatial position and orientation specifications, namely:

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >55 mm*>151.70 mm*>=1 mm;

4) the spatial position and orientation of the heat sink metallic plate relative to the shield 406 may be such that the heat sink metallic plate may be juxtaposed beneath the shield 406 and coupled therewith;

5) the material of the composite modular shield 406 may be ferrite;

6) the constructional design or structure of the shield 406 may be a composite modular type;

7) the total number of shield blocks 806B, 808B and 810B constituting the shield 406 may be 3;

6) the optional geometry of each of the shield blocks of the shield 406 may be a thin (or laminar) three-dimensional (3D) solid rectangular cuboid with or without rounded corners;

9) the length, breadth and height, i.e. dimensions, of the each of the shield blocks of the pair of shield blocks 806B and 808B of the shield 406 may be approximately 55 mm*70.35 mm*1 mm;

10) the length, breadth and height, i.e. dimensions, of the shield block 810B of the shield 406 may be approximately 55 mm*11 mm*0.7 mm;

11) the length and breadth, i.e. dimensions, of each of the transmitter coils in the transmitter coil array 410 may be approximately 45.20 mm*53.2 mm;

12) the total number of transmitter coils in the transmitter coil array 410 may be 6,

13) the optional geometry of each of the transmitter coils in the transmitter coil array 410 may be thin three-dimensional (3D) hollow rectangular ring with rounded corners;

14) the relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and may be positioned immediately beneath each of the even numbered transmitter coils;

15) the relative inter-coil spatial positioning of the odd numbered transmitter coils may be such that the first 410A, third 410C and fifth 410E transmitter coils in that order may be juxtaposed in close vicinity to each other in a continuous linear fashion;

16) the relative inter-coil spatial positioning of the even numbered transmitter coils may be such that the second 410B, fourth 410D and sixth 410F transmitter coils in that order may be proximately juxtaposed to each other in a continuous linear fashion;

17) the relative inter-coil spatial positioning of both even and odd numbered transmitter coils may be such that each of the even numbered transmitter coils may partially overlap with a pair of immediately preceding and proceeding odd numbered transmitter coils;

18) the total inter transmitter coil array 410 and the shield 406 length-wise edge spacing may be approximately 5 mm, i.e. the total lengthwise spacing between the edges of the transmitter coil array 410 and the edges of the shield 406 may preferably be approximately 5 mm;

19) the total inter transmitter coil array 410 and the shield 406 breadth-wise edge spacing may be approximately 0 mm, i.e. the total breadth-wise spacing between the edges of the transmitter coil array 410 and the edges of the shield 406 may be approximately 0 mm;

20) the inter external proximal edge distance between the first and second transmitter coils 410A and 410B, i.e. the distance between the outer proximal edges of the first and second transmitter coils 410A and 410B, may be approximately 16.10 mm;

21) the distance between the inner distal edge of the second transmitter coil 410B and the inner proximal edge of the third transmitter coil 410C may be approximately 9.5 mm; and

22) the distance between the inner distal edge of the fourth transmitter coil 410D and the inner proximal edge of the fifth transmitter coil 410E may be approximately 9.5 mm.

In some embodiments, the shield may comprise of one or more sets of shield blocks. Specifically, each set of the sets of shield blocks may possess homogeneous specifications, for instance material, constructional, dimensional, geometrical, spatial position and orientation specifications therefor. More specifically, each shield block of the sets of shield blocks forming the shield may be juxtaposed in at least one of proximity and vicinity of each other thereby resulting in, or allowing or maintaining, a selectively adjustable gap therebetween. In some embodiments, the selectively adjustable gap may be at least one of void and filled with an appropriate material. Specifically, the material for filling the gap may be at least one of thermally conductive, electrically insulative, magnetically insulative and a combination thereof. More specifically, the gap-fill material may be a shield with a relatively lower profile vis-à-vis the shield blocks.

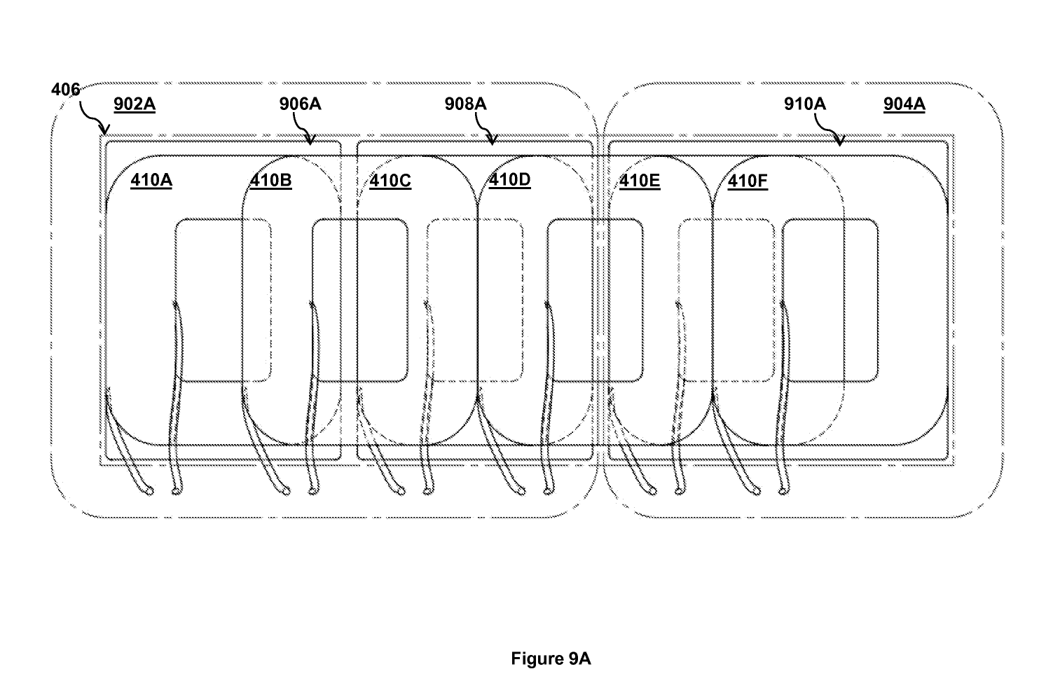

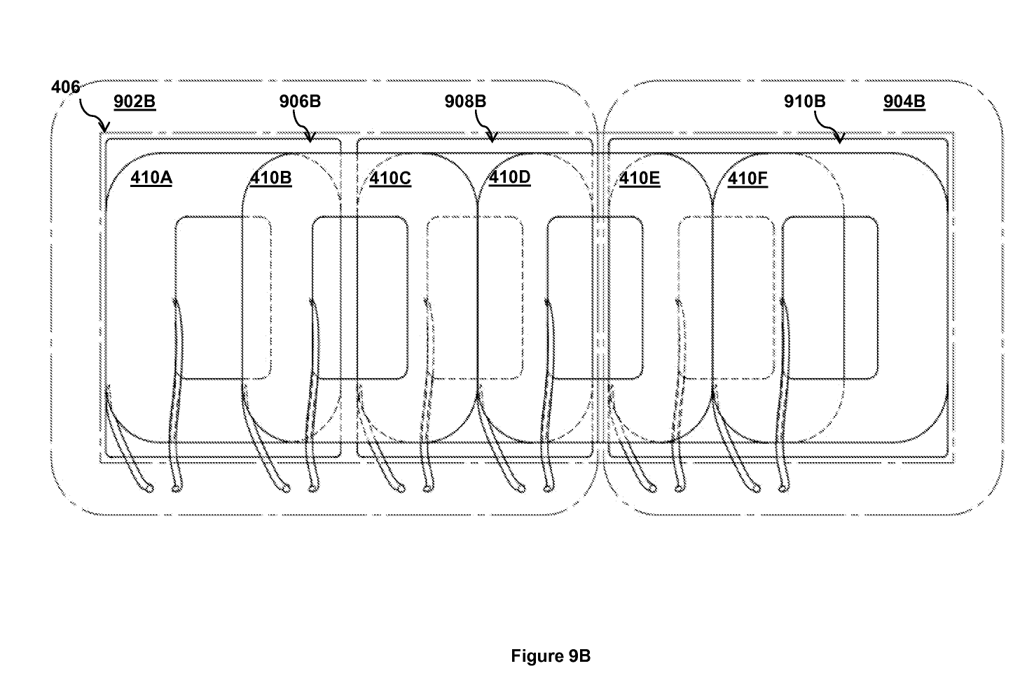

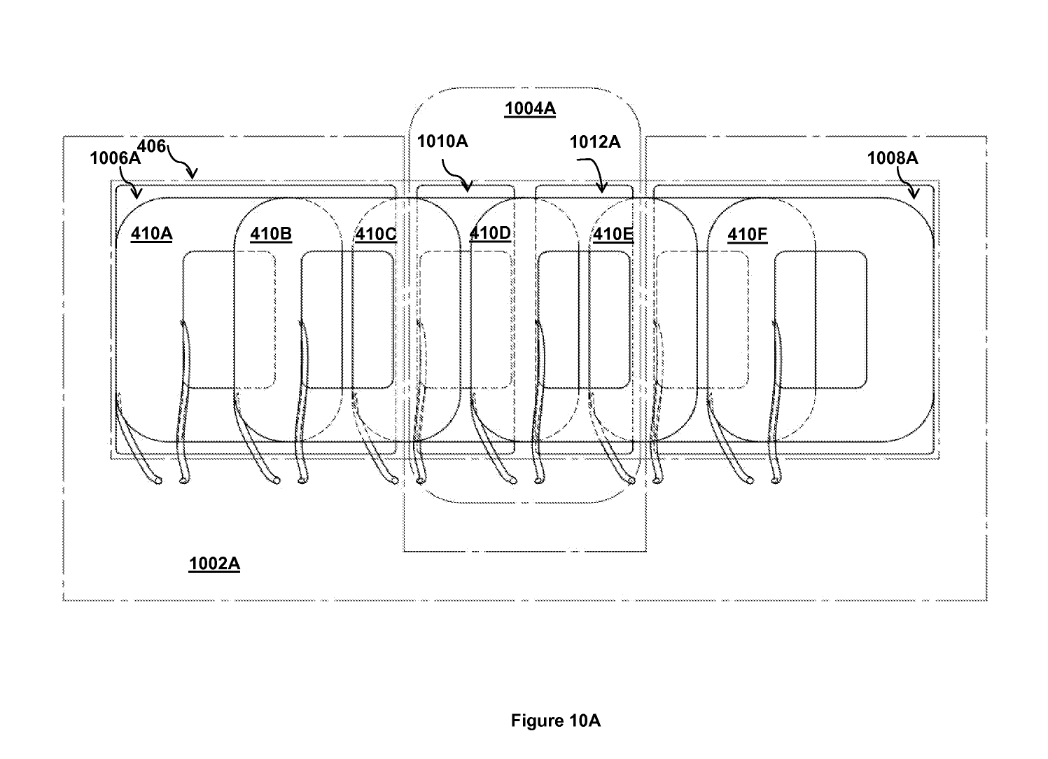

FIG. 9A depicts a fourth potential overall physical configuration in connection with the charging subunit 402, and transmitter coil array 410 thereof, of FIG. 4, in accordance with one or more embodiments.

As depicted in FIG. 9A, the shield 406 may possess a composite modular design. For example, and in no way limiting the scope of the invention, the shield 406 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and second set of shield blocks 902A and 904A. For example, and in no way limiting the scope of the invention, the first set of shield blocks 902A may include a pair of shield blocks, namely a first and second shield blocks 906A and 908A, with homogeneous specifications, for instance material, constructional, dimensional, geometrical, spatial position and orientation specifications therefor. For example, and in no way limiting the scope of the invention, the second set of shield blocks 904A may include a single shield block, namely a third shield block 910A with distinct specifications.

As depicted in FIG. 9A, for example, and in no way limiting the scope of the invention, in accordance with the fourth potential overall physical configuration the charging subunit 402, and transmitter coil array 410 thereof, may possess the following material, constructional, dimensional, geometrical, spatial position and orientation specifications, namely:

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >55 mm*>154 mm*>=1 mm;

4) the spatial position and orientation of the heat sink metallic plate relative to the shield 406 may be such that the heat sink metallic plate may be juxtaposed beneath the shield 406 and coupled therewith;

5) the material of the shield 406 may be ferrite;

6) the constructional design or structure of the shield 406 may be a composite modular type;

7) the total number of shield blocks 906A, 908A and 910A constituting the shield 406 may be 3;

8) the optional geometry of each of the shield blocks of the shield 406 may be a thin (or laminar) three-dimensional (3D) solid rectangular cuboid with or without rounded corners;

9) the length, breadth and height, i.e. dimensions, of the each of the shield blocks of the pair of shield blocks 906A and 908A of the shield 406 may be approximately 50 mm*43 mm*1 mm;

10) the length, breadth and height, i.e. dimensions, of the shield block 910A of the shield 406 may be approximately 55 mm*62 mm*1 mm;

11) the length and breadth, i.e. dimensions, of each of the transmitter coils in the transmitter coil array 410 may be approximately 50 mm*43 mm;

12) the total number of transmitter coils in the transmitter coil array 410 may be 6;

13) the optional geometry of each of the transmitter coils in the transmitter coil array 410 may be a thin three-dimensional (3D) hollow rectangular ring with rounded corners;

14) the relative spatial positioning of each of the transmitter coils in the transmitter coil array 410 with respect to the shield 106 may be such that each of the odd numbered transmitter coils, namely the first 410A, third 410C and fifth 410E in that order, may be directly coupled to the shield 106, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and may be positioned immediately beneath each of the even numbered transmitter coils;

15) the relative inter-coil spatial positioning of the odd numbered transmitter coils may be such that the first 410A, third 410C and fifth 410E transmitter coils in that order may be juxtaposed in close vicinity to each other in a continuous linear fashion;

16) the relative inter-coil spatial positioning of the even numbered transmitter coils may be such that the second 410B, fourth 410D and sixth 410F transmitter coils in that order may be proximately juxtaposed to each other in a continuous linear fashion;

17) the relative inter-coil spatial positioning of both even and odd numbered transmitter coils may be such that each of the even numbered transmitter coils may partially overlap with a pair of immediately preceding and proceeding odd numbered transmitter coils;

18) the total inter transmitter coil array 410 and the shield 406 length-wise edge spacing may be approximately 5 mm, i.e. the total lengthwise spacing between the edges of the transmitter coil array 110 and the edges of the shield 406 may preferably be less than approximately 5 mm;

19) the total inter transmitter coil array 410 and the shield 406 breadth-wise edge spacing may be approximately 0 mm, i.e. the total breadth-wise spacing between the edges of the transmitter coil array 410 and the edges of the shield 406 may be approximately 0 mm;

20) the inter external proximal edge distance between the first and second transmitter coils 410A and 410B, i.e. the distance between the outer proximal edges of the first and second transmitter coils 410A and 410B, may be approximately 25 mm;

21) the distance between the outer distal edge of the first transmitter coil 410A and the outer distal edge of the second transmitter coil 410B, or the outer proximal edge of the fourth transmitter coil 410D, may be approximately 25 mm;

22) the distance between the outer distal edge of the second transmitter coil 410B, or the outer proximal edge of the fourth transmitter coil 410C, and the outer proximal edge of the fifth transmitter coil 410E may be approximately 24 mm;

23) the distance between the outer proximal edges of the fifth transmitter coil 410E and the sixth transmitter coil 410F may be approximately 22 mm;

24) the distance between the inner distal edge of the first transmitter coil 410A and the inner proximal edge of the second transmitter coil 410B may be approximately 7.6 mm;

25) the distance between the inner distal edge of the second transmitter coil 410B and the inner proximal edge of the third transmitter coil 410C may be approximately 3.6 mm;

26) the distance between the inner distal edge of the third transmitter coil 410C and the inner proximal edge of the fourth transmitter coil 410D may be approximately 4.6 mm;

27) the distance between the inner distal edge of the fourth transmitter coil 410D and the inner proximal edge of the fifth transmitter coil 410E may be approximately 6.6 mm;

28) the distance between the inner distal edge of the fifth transmitter coil 410E and the inner proximal edge of the sixth transmitter coil may be approximately 1.6 mm;

29) the distance between the inner distal edge of the fourth transmitter coil 410D and the inner proximal edge of the fifth transmitter coil 110E may be approximately 9.5 mm; and

30) the width of the selectively adjustable gap between the first and second shield blocks 906A and 908A may be approximately 3 mm; and

31) the width of the selectively adjustable gap between the second and third shield blocks may be approximately 3 mm.

FIG. 9B depicts a fifth potential overall physical configuration in connection with the charging subunit 402, and transmitter coil array 410 thereof, of FIG. 4, in accordance with one or more embodiments.

As depicted in FIG. 9B, the shield 406 may possess a composite modular design. For example, and in no way limiting the scope of the invention, the shield 406 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and second set of shield blocks 902B and 904B. For example, and in no way limiting the scope of the invention, the first set of shield blocks 902B may include a pair of shield blocks, namely a first and second shield blocks 906B and 908B, with homogeneous specifications, for instance material, constructional, dimensional, geometrical, spatial position and orientation specifications therefor. For example, and in no way limiting the scope of the invention, the second set of shield blocks 904B may include a single shield block, namely a third shield block 910B with distinct specifications.

As depicted in FIG. 9B, for example, and in no way limiting the scope of the invention, in accordance with the fourth potential overall physical configuration the charging subunit 402, and transmitter coil array 410 thereof, may possess the following material, constructional, dimensional, geometrical, spatial position and orientation specifications, namely

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >55 mm*>163.10 mm*>=1 mm;

4) the spatial position and orientation of the heat sink metallic plate relative to the shield 406 may be such that the heat sink metallic plate may be juxtaposed beneath the shield 406 and coupled therewith;

5) the material of the shield 406 may be ferrite;

6) the constructional design or structure of the shield 406 may be composite modular type;

7) the total number of shield blocks 906B, 908B and 910B constituting the shield 406 may be 3;

8) the optional geometry of each of the shield blocks of the shield 406 may be a thin (or laminar) three-dimensional (3D) solid rectangular cuboid with or without rounded corners;

9) the length, breadth and height, i.e. dimensions, of the each of the shield blocks of the pair of shield blocks, namely first and second 906B and 908B of the shield 406 may be approximately 55 mm*45.20 mm*1 mm;

10) the length, breadth and height, i.e. dimensions, of the third shield block 910B of the shield 406 may be approximately 55 mm*66.70 mm*1 mm;

11) the length and breadth, i.e. dimensions, of each of the transmitter coils in the transmitter coil array 410 may be approximately 53.20 mm*45.20 mm;

12) the total number of transmitter coils in the transmitter coil array 410 may be 6;

13) the optional geometry of each of the transmitter coils in the transmitter coil array 410 may be a thin three-dimensional (3D) hollow rectangular ring with rounded corners;

14) the relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and positioned immediately beneath each of the even numbered transmitter coils;

15) the relative inter-coil spatial positioning of the odd numbered transmitter coils may be such that the first 410A, third 410C and fifth 410E transmitter coils in that order may be juxtaposed in close vicinity to each other in a continuous linear fashion;

16) the relative inter-coil spatial positioning of the even numbered transmitter coils may be such that the second 410B, fourth 410D and sixth 410F transmitter coils in that order may be proximately juxtaposed to each other in a continuous linear fashion;

17) the relative inter-coil spatial positioning of both even and odd numbered transmitter coils may be such that each of the even numbered transmitter coils may partially overlap with a pair of immediately preceding and proceeding odd numbered transmitter coils;

18) the total inter transmitter coil array 410 and the shield 406 length-wise edge spacing may be approximately 5 mm, i.e. the total lengthwise spacing between the edges of the transmitter coil array 410 and the edges of the shield 406 may preferably be approximately 5 mm;

19) the total inter transmitter coil array 410 and the shield 406 breadth-wise edge spacing may be approximately 0 mm, i.e. the total breadth-wise spacing between the edges of the transmitter coil array 410 and the edges of the shield 406 may be approximately 0 mm;

20) the inter external proximal edge distance between the first and second transmitter coils 410A and 410B, i.e. the distance between the outer proximal edges of the first and second transmitter coils 410A and 410B, may be approximately 27.50 mm;

21) the distance between the outer distal edge of the first transmitter coil 410A and the outer distal edge of the second transmitter coil 410B, or the outer proximal edge of the fourth transmitter coil 410D, may be approximately 27.50 mm;

22) the distance between the outer distal edge of the second transmitter coil 410B, or the outer proximal edge of the fourth transmitter coil 410C, and the outer proximal edge of the fifth transmitter coil 410E may be approximately 23.70 mm;

23) the distance between the outer proximal edges of the fifth transmitter coil 410E and the sixth transmitter coil 410F may be approximately 24.50 mm;

24) the distance between the inner distal edge of the first transmitter coil 410A and the inner proximal edge of the second transmitter coil 410B may be approximately 7.9 mm;

25) the distance between the inner distal edge of the second transmitter coil 410B and the inner proximal edge of the third transmitter coil 410C may be approximately 1.1 mm;

26) the distance between the inner distal edge of the third transmitter coil 410C and the inner proximal edge of the fourth transmitter coil 410D may be approximately 4.9 mm;

27) the distance between the inner distal edge of the fourth transmitter coil 410D and the inner proximal edge of the fifth transmitter coil 410E may be approximately 4.1 mm;

28) the distance between the inner distal edge of the fifth transmitter coil 410E and the inner proximal edge of the sixth transmitter coil 410F may be approximately 1.9 mm;

29) the width of the selectively adjustable gap between the first and second shield blocks 906B and 908B may be approximately 3 mm; and

30) the width of the selectively adjustable gap between the second and third shield blocks 908B and 910B may be approximately 3 mm.

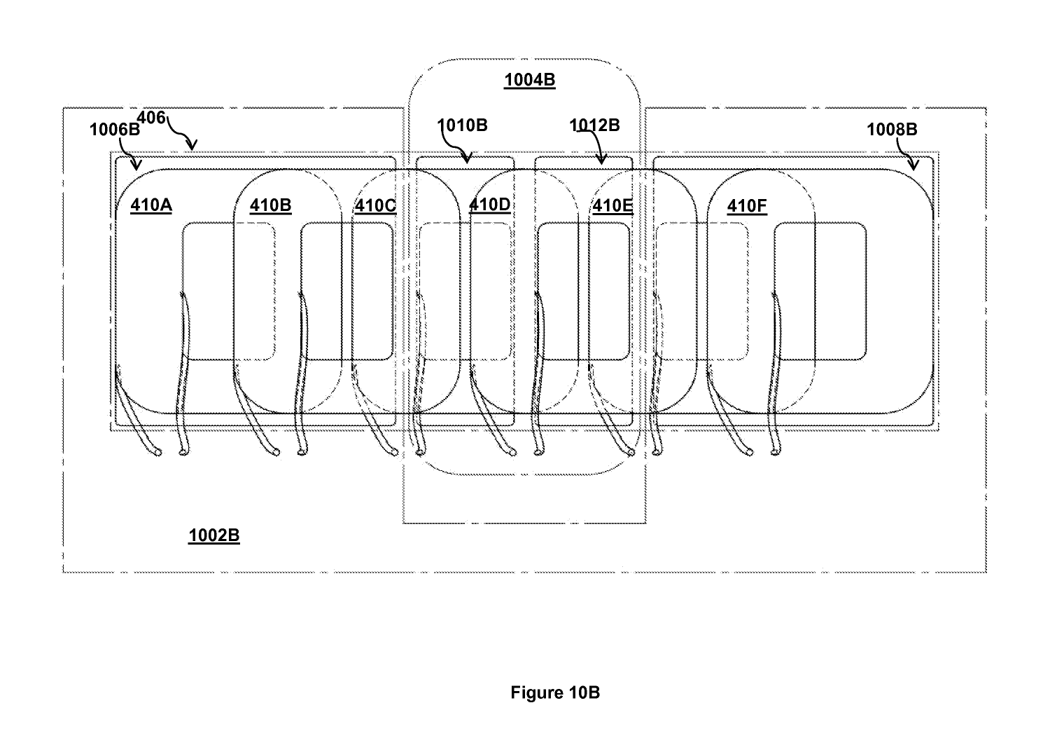

FIG. 10A depicts a seventh potential overall physical configuration in connection with the charging subunit 402, and transmitter coil array 410 thereof, of FIG. 4, in accordance with one or more embodiments.

As depicted in FIG. 10A, the shield 406 may possess a composite modular design. For example, and in no way limiting the scope of the invention, the shield 406 may include at least two heterogeneous pairs of shield blocks, wherein each pair of shield blocks of the two pairs of shield blocks may possess homogeneous specifications, for instance material, constructional, dimensional, geometrical, spatial position and orientation specifications therefor. For purposes of clarity and expediency, the two heterogeneous pairs of shield blocks may be hereinafter referred to as a first and second pairs of shield blocks 1002A and 1004A. For example, and in no way limiting the scope of the invention, the first pair of shield blocks 1002A may include a pair of shield blocks, namely a first and second shield blocks 1006A and 1008A, with unique homogeneous specifications, for instance material, constructional, dimensional, geometrical, spatial position and orientation specifications therefor. For example, and in no way limiting the scope of the invention, the second pair of shield blocks 1004A may include a pair of shield blocks, namely a third and fourth shield blocks 1010A and 1012A with unique homogeneous specifications.

As depicted in FIG. 10A, for example, and in no way limiting the scope of the invention, in accordance with the fourth potential overall physical configuration the charging subunit 402, and transmitter coil array 410 thereof, may possess the following material, constructional, dimensional, geometrical, spatial position and orientation specifications, namely

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >55 mm*>155.50 mm*>=1 mm;

4) the spatial position and orientation of the heat sink metallic plate relative to the shield 406 may be such that the heat sink metallic plate may be juxtaposed beneath the shield 406 and coupled therewith;

5) the material of the shield 406 may be ferrite;

6) the constructional design or structure of the shield 406 may be a composite modular type;

7) the total number of shield blocks 1006A, 1008A, 1010A and 1012A constituting the shield 406 may be 4;

8) the optional geometry of each of the shield blocks of the shield 406 may be a thin (or laminar) three-dimensional (3D) solid rectangular cuboid with or without rounded corners;

9) the length, breadth and height, i.e. dimensions, of the each of the shield blocks of the first pair of shield blocks 1002A, including the first and second shield blocks 1006A and 1008A, of the shield 406 may be approximately 55 mm*53.25 mm*1 mm;

10) the length, breadth and height, i.e. dimensions, of each of the shield blocks of the second pair of shield blocks 1004A, including the third and fourth shield blocks 1010A and 1012A, of the shield 406 may be approximately 55 mm*18.50 mm*1 mm;

11) the length and breadth, i.e. dimensions, of each of the transmitter coils in the transmitter coil array 410 may be approximately 50 mm*43 mm;

12) the total number of transmitter coils in the transmitter coil array 410 may be 6;

13) the optional geometry of each of the transmitter coils in the transmitter coil array 410 may be a thin three-dimensional (3D) hollow rectangular ring with rounded corners;

14) the relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and may be thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and positioned immediately beneath each of the even numbered transmitter coils;

15) the relative inter-coil spatial positioning of the odd numbered transmitter coils may be the first 410A, third 410C and fifth 410E transmitter coils in that order may be juxtaposed in close vicinity to each other in a continuous linear fashion;

16) the relative inter-coil spatial positioning of the even numbered transmitter coils may be the second 410B, fourth 410D and sixth 410F transmitter coils in that order may be proximately juxtaposed to each other in a continuous linear fashion;

17) the relative inter-coil spatial positioning of both even and odd numbered transmitter coils may be such that each of the even numbered transmitter coils may partially overlap with a pair of immediately preceding and proceeding odd numbered transmitter coils;

18) the total inter transmitter coil array 410 and the shield 406 length-wise edge spacing may be approximately 5 mm, i.e. the total lengthwise spacing between the edges of the transmitter coil array 410 and the edges of the shield 106 may preferably be approximately 5 mm;

19) the total inter transmitter coil array 410 and the shield 406 breadth-wise edge spacing may be approximately 0 mm, i.e. the total breadth-wise spacing between the edges of the transmitter coil array 410 and the edges of the shield 406 may be approximately 0 mm;

20) the inter external proximal edge distance between the first and second transmitter coils 410A and 410B, i.e. the distance between the outer proximal edges of the first and second transmitter coils 410A and 410B, may be approximately 22.50 mm;

21) the distance between the outer distal edge of the first transmitter coil 410A and the outer proximal edge of the fourth transmitter coil 410D may be approximately 24.50 mm;

22) the distance between the outer proximal edge of the fourth transmitter coil 410D and the outer proximal edge of the fifth transmitter coil 410E may be approximately 24.50 mm;

23) the distance between the outer proximal edges of the fifth transmitter coil 410E and the sixth transmitter coil 410F may be approximately 24.50 mm;

24) the distance between the inner distal edge of the first transmitter coil 410A and the inner proximal edge of the second transmitter coil 410B may be approximately 5.1 mm;

25) the distance between the inner distal edge of the second transmitter coil 410B and the inner proximal edge of the third transmitter coil 410C may be approximately 5.1 mm;

26) the distance between the inner distal edge of the third transmitter coil 410C and the inner proximal edge of the fourth transmitter coil 410D may be approximately 5.1 mm;

27) the distance between the inner distal edge of the fourth transmitter coil 410D and the inner proximal edge of the fifth transmitter coil 410E may be approximately 5.1 mm;

28) the distance between the inner distal edge of the fifth transmitter coil 410E and the inner proximal edge of the sixth transmitter coil 410F may be approximately 5.1 mm;

29) the width of the selectively adjustable gap between the first and third shield blocks 1006A and 1010A may be approximately 4 mm;

30) the width of the selectively adjustable gap between the third and fourth shield blocks 1010A and 1012A may be approximately 4 mm; and

31) the width of the selectively adjustable gap between the fourth and second shield blocks 1012A and 1008A may be approximately 4 mm.

FIG. 10B depicts an eighth potential overall physical configuration in connection with the charging subunit 402, and transmitter coil array 410 thereof, of FIG. 4, in accordance with one or more embodiments.

As depicted in FIG. 10B, the shield 406 may possess a composite modular design. For example, and in no way limiting the scope of the invention, the shield 406 may include at least two heterogeneous pairs of shield blocks, wherein each pair of shield blocks of the two pairs of shield blocks may possess homogeneous specifications, for instance material, constructional, dimensional, geometrical, spatial position and orientation specifications therefor. For purposes of clarity and expediency, the two heterogeneous pairs of shield blocks may be hereinafter referred to as a first and second pairs of shield blocks 1002B and 1004B. For example, and in no way limiting the scope of the invention, the first pair of shield blocks 1002B may include a pair of shield blocks, namely a first and second shield blocks 1006B and 1008B, with unique homogeneous specifications, for instance material, constructional, dimensional, geometrical, spatial position and orientation specifications therefor. For example, and in no way limiting the scope of the invention, the second pair of shield blocks 1004B may include a pair of shield blocks, namely a third and fourth shield blocks 1010B and 1012B with unique homogeneous specifications.

As depicted in FIG. 10B, for example, and in no way limiting the scope of the invention, in accordance with the fourth potential overall physical configuration the charging subunit 402, and transmitter coil array 410 thereof, may possess the following material, constructional, dimensional, geometrical, spatial position and orientation specifications, namely

1) the material of a heat sink metallic plate (not shown and numbered here explicitly) may be a metal, for instance silver;

2) the optional geometry of the heat sink metallic plate may be a thin (or laminar) three-dimensional (3D) solid rectangular cuboid with or without rounded corners;

3) the length, breadth and height, i.e. dimensions, of the heat sink metallic plate may be approximately >56.20 mm*>161.80 mm*>=1 mm;

4) the spatial position and orientation of the heat sink metallic plate relative to the shield 406 may be such that the heat sink metallic plate may be juxtaposed beneath the shield 406 and coupled therewith;

5) the material of the shield 406 may be ferrite;

6) the constructional design or structure of the shield 406 may be a composite modular type;

7) the total number of shield blocks 1006B, 1008B, 10108 and 1012B constituting the shield 406 may be 4;

8) the optional geometry of each of the shield blocks of the shield 406 may be a thin (or laminar) three-dimensional (3D) solid rectangular cuboid with or without rounded corners;

9) the length, breadth and height, i.e. dimensions, of the each of the shield blocks of the first pair of shield blocks 1002B, including the first and second shield blocks 1006B and 1008B, of the shield 406 may be approximately 56.20 mm*54.90 mm*1 mm;

10) the length, breadth and height, i.e. dimensions, of each of the shield blocks of the second pair of shield blocks 1004B, including the third and fourth shield blocks 1010B and 1012B, of the shield 406 may be approximately 56.20 mm*20 mm*1 mm;

11) the length and breadth, i.e. dimensions, of each of the transmitter coils in the transmitter coil array 410 may be approximately 53.20 mm*45.20 mm;

12) the total number of transmitter coils in the transmitter coil array 410 may be 6,

13) the optional geometry of each of the transmitter coils in the transmitter coil array 410 may be a thin three-dimensional (3D) hollow rectangular ring with rounded corners;

14) the relative spatial positioning of each of the transmitter coils in the transmitter coil array 410 with respect to the shield 406 may be such that each of the odd numbered transmitter coils, namely the first 410A, third 410C and fifth 410E in that order, may be directly coupled to the shield 406, and are thus positioned thereupon, whereas each of the even numbered transmitter coils, namely the second 410B, fourth 410D and sixth 410F in that order, may be directly coupled to a pair of immediately preceding and proceeding odd numbered transmitter coils, flanking, or juxtaposed to, each other, and positioned immediately beneath each of the even numbered transmitter coils;

15) the relative inter-coil spatial positioning of the odd numbered transmitter coils may be such that the first 410A, third 410C and fifth 410E transmitter coils in that order may be juxtaposed in close vicinity to each other in a continuous linear fashion;

16) the relative inter-coil spatial positioning of the even numbered transmitter coils may be such that the second 410B, fourth 410D and sixth 410F transmitter coils in that order may be proximately juxtaposed to each other in a continuous linear fashion;

17) the relative inter-coil spatial positioning of both even and odd numbered transmitter coils may be such that each of the even numbered transmitter coils may partially overlap with a pair of immediately preceding and proceeding odd numbered transmitter coils;

18) the total inter transmitter coil array 410 and the shield 406 length-wise edge spacing may be approximately 5 mm, i.e. the total lengthwise spacing between the edges of the transmitter coil array 410 and the edges of the shield 406 may preferably be approximately 5 mm;

19) the total inter transmitter coil array 410 and the shield 106 breadth-wise edge spacing may be approximately 0.60 mm, i.e. the total breadth-wise spacing between the edges of the transmitter coil array 410 and the edges of the shield 406 may be approximately 0.60 mm;

20) the inter external proximal edge distance between the first and second transmitter coils 410A and 410B, i.e. the distance between the outer proximal edges of the first and second transmitter coils 410A and 410B, may be approximately 23.20 mm;

21) the distance between the outer distal edge of the first transmitter coil 410A and the outer proximal edge of the third transmitter coil 410B may be approximately 1.20 mm;

22) the distance between the outer distal edge of the first transmitter coil 410A and the outer proximal edge of the fourth transmitter coil 410D may be approximately 24.40 mm;

23) the distance between the outer distal edge of the second transmitter coil 410B and the outer proximal edge of the fourth transmitter coil 410D may be approximately 1.20 mm;

24) the distance between the outer distal edge of the second transmitter coil 410B and the outer proximal edge of the fifth transmitter coil 410E may be approximately 24.40 mm;

25) the distance between the outer distal edge of the third transmitter coil 410C and the outer proximal edge of the sixth transmitter coil 410F may be approximately 24.40 mm;

24) the distance between the inner distal edge of the first transmitter coil 410A and the inner proximal edge of the second transmitter coil 410B may be approximately 3.6 mm;

25) the distance between the inner distal edge of the second transmitter coil 410B and the inner proximal edge of the third transmitter coil 410C may be approximately 3.6 mm;

26) the distance between the inner distal edge of the third transmitter coil 410C and the inner proximal edge of the fourth transmitter coil 410D may be approximately 3.6 mm;

27) the distance between the inner distal edge of the fourth transmitter coil 410D and the inner proximal edge of the fifth transmitter coil 410E may be approximately 3.6 mm;

28) the distance between the inner distal edge of the fifth transmitter coil 410E and the inner proximal edge of the sixth transmitter coil 410F may be approximately 3.6 mm;

29) the distance between the outer distal edge of the third transmitter coil 410C and the outer proximal edge of the fifth transmitter coil 410E may be approximately 1.20 mm;

30) the distance between the outer distal edge of the fourth transmitter coil 410D and the outer proximal edge of the sixth transmitter coil 410F may be approximately 1.20 mm;

31) the width of the selectively adjustable gap between the first and third shield blocks 1006B and 10108 may be approximately 4 mm;

32) the width of the selectively adjustable gap between the third and fourth shield blocks 1010B and 1012B may be approximately 4 mm; and

31) the width of the selectively adjustable gap between the fourth and second shield blocks 1012B and 1008B may be approximately 4 mm.

In some embodiments, the one or more potential overall physical configurations in connection with the transmitter coil array 410 of the charging subunit 402, of FIG. 4, disclosed in accordance with one or more embodiments may be selectively adopted thereby facilitating realization of one or more transmitter coil array 410 with corresponding overall specifications therefor.

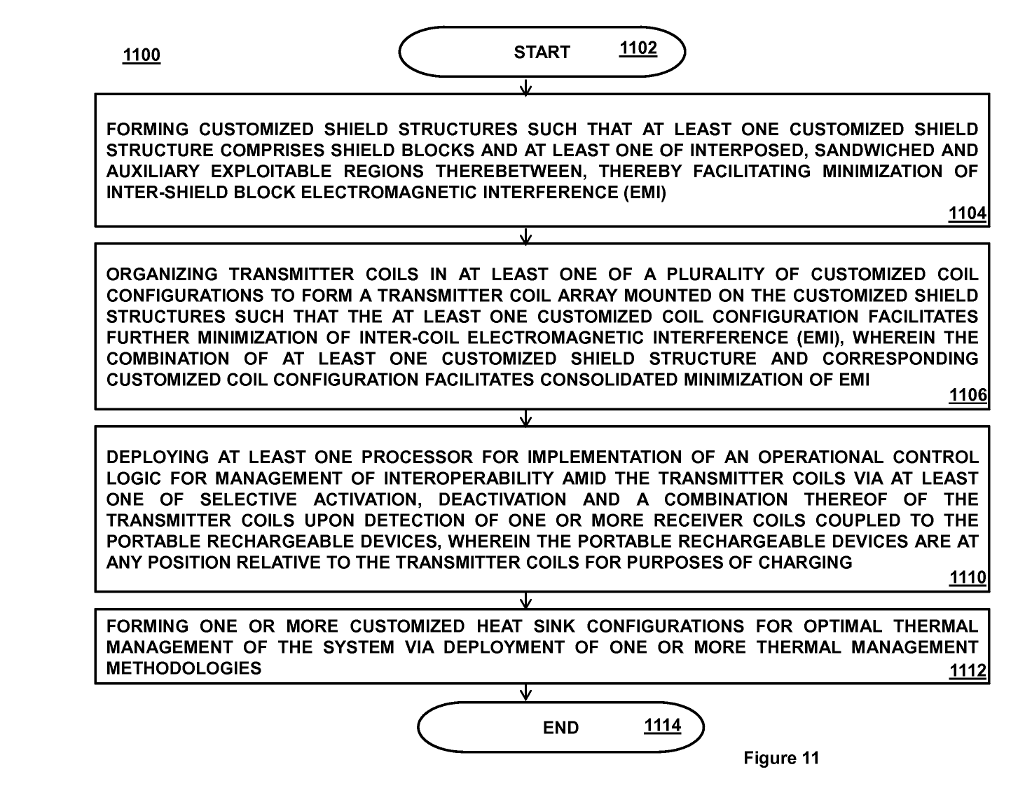

FIG. 11 depicts a flow diagram of a method for design and implementation of a system facilitating seamless and simultaneous wireless charging of portable rechargeable devices with Adaptive Positioning Free (APF) capability, according to one or more embodiments.

The method 1100 may start at step 1102 and proceed to step 1104. At step 1104, the method 1100 may comprise, or facilitate, forming a plurality of customized shield structures, wherein at least one of the customized shield structures comprises one or more shield blocks and at least one of interposed, sandwiched and auxiliary exploitable regions or spaces therebetween, thereby facilitating at least one of minimization and zeroization of inter-shield block Electromagnetic Interference (EMI).

In some embodiments, the customized shield structures may be formed using at least one of compact modular and monolithic shield, for instance shield 406 of FIG. 4. For example, and in no way limiting the scope of the invention, the material of the shield 406 may be ferrite.

For example, and in no way limiting the scope of the invention, the customized shield structures may be same as disclosed in detail in conjunction with FIGS. 8A-B, 9A-B and 10A-B respectively.

At step 1104, the method 1100 may further comprise, or facilitate, selectively adopting at least one of the plurality of customized shield structures formed, depending upon the requirements specifications.

In some embodiments, the at least one of interposed, sandwiched and auxiliary exploitable regions or spaces between the shield blocks may be at least one of void and filled. For example, and in no way limiting the scope of the invention, in some embodiments the spaces may be filled with an apt gap-fill material, which is at least one of electrically and magnetically insulative and thermally conductive. Specifically, the gap-fill material may be at least one of solid and perforated, and at least one of transparent, translucent and opaque with a thickness relatively lesser vis-à-vis the shield blocks.

At step 1106, the method 1100 may comprise, or facilitate, organizing or arranging one or more transmitter coils in at least one of a plurality of customized coil configurations to form at least one transmitter coil array mounted on at least one of the selectively adopted customized shield structures such that the customized coil configuration facilitate further minimization of inter-coil Electromagnetic Interference (EMI), wherein the combination of at least one the selectively adopted customized shield structure and corresponding customized coil configuration facilitates overall or consolidated minimization of the inter-coil EMI.

At step 1106, the method 1100 may further comprise, or facilitate, selectively adopting at least one of the plurality of customized coil configurations depending upon the requirements specifications.

In some embodiments, one or more of the plurality of customized coil configurations may comprise one or more transmitter coils arranged or organized in the form a multi-layer (-tier) structure or configuration, wherein each layer may comprise at least one transmitter coil array. For example, and in no way limiting the scope of the invention, the multi-layer (-tier) structure or configuration may comprise at least two layers.

At step 1110, the method 1100 may comprise, or facilitate, deploying at least one processor for implementation of an operational control logic for management of interoperability amid the transmitter coils via at least one of selective activation, deactivation and a combination thereof of the transmitter coils upon detection of one or more receiver coils coupled to the portable rechargeable devices, wherein the portable rechargeable devices may be manually positioned at any position relative to the transmitter coils for purposes of charging. For example, and in no way limiting the scope of the invention, the at least one processor may be a controller, for instance the first controller 408 of FIG. 4.

At step 1112, the method 1100 may comprise, or facilitate, forming one or more customized heat sink configurations for optimal thermal management of the system via deployment of one or more thermal management methodologies. For example, and in no way limiting the scope of the invention, the thermal management methodologies may comprise use of at least one of Phase Change Materials (PCMs) and synthetic diamond. Specifically, the PCMs may be classified into organic PCMs, inorganic, eutectic and hygroscopic materials.

The method 1100 may end at step 1114.

In some embodiments, an interoperability plan or scheme in connection with the transmitter coils of the transmitter coil array based at least in part on one or more customized shield structures, customized coil configurations and a combination thereof is disclosed, in accordance with the principles of the present invention.

In some embodiments, at least one of random, sequential and selectively controlled scanning of one or more transmitter coils in the transmitter coil array of the charging subsystem is disclosed, in accordance with the principles of the present invention. Specifically, each of the one or more transmitter coils may be scanned via pinging each of the transmitter coils in at least one of random, sequential and selectively controlled manner, wherein the inter-coil pinging time interval is at least one of negligibly and infinitesimally small. More specifically, the width of each pulse signal, often called a “ping”, used for scanning each of the transmitter coils is small. For example, and in no way limiting the scope of the invention, the width of the pulse signal is approximately 100 ms. Consequently, the time period for completion of each scanning cycle comprising scanning via pinging each of the transmitter coils using a corresponding single pulse signal is relatively large thereby resulting in perceptibly (or noticeably) long wait time for scanning one or more transmitter coils confined to a given distal end (i.e. at least one of a given fartherest and ending point relative to a given starting point for a given direction of scanning in a given scanning cycle) of any given contiguous configuration of the transmitter coil array. For example in at least one of a left-to-right sequential directional scanning, for instance starting at the first transmitter coil, for instance 410A of FIG. 4, of the transmitter coil array 410 with six (6) transmitter coils, for instance 410A-F, and sequentially propagating to the sixth transmitter coil 410F the total time elapsed may be approximately 600 ms, whereas for right-to-left sequential directional scanning, for instance starting at the sixth transmitter coil, for instance 410F of FIG. 4, of the transmitter coil array 410 with six (6) transmitter coils, for instance 410A-F, and sequentially propagating to the first transmitter coil 410A the total time elapsed may be approximately 600 ms. In some embodiments, reduction in scanning cycle time period thereby facilitating minimization of time consumption is disclosed, in accordance with the principles of the present invention.

As used herein, the term “digital ping” refers to the application of a power signal in order to detect and identify a power receiver.

As used herein, the term “analog ping” refers to a method that does not involve waking up the receiver and starting digital communications. Typically zero or more analog pings precede the digital ping.

The implementation of the analog and digital pinging features may be performed in different embodiments. The advantage of using the analog or digital ping signal is the ability to determine whether or not the portable computing and communications device (or portable chargeable device) is still on the charging subsystem. The aforementioned usage of the analog or digital ping signal may be advantageous, for example, in the event that a second power source, i.e. battery of the portable computing and communications device (or portable chargeable device), is full and the receiver coil therefor is in standby mode. WPC also defines the usage of pinging signals in the transmitter coil to determine whether an object is placed on the charging subsystem and whether the possibly detected object is operable for wireless charging. It is also be noted that with the analog pinging, the receiver coil needs to be powered by the I/O voltage while with digital ping the receiver coil may use the power delivered by the transmitter coil.

In some embodiments, the transmitter coil array may be virtually (or logically) partitioned into one or more homogeneous sets of transmitter coils thereby facilitating concurrent scanning of each of the homogeneous sets of transmitter coils.

Embodiments of the present invention also relate to a system for mounting and reconfiguring electrical loads over wirelessly powered physical surfaces. The system comprises at least one of a customized wireless power capable and retrofitted wireless power enabled physical surface. The physical surface comprises at least one physical surface module. Each physical surface module comprises a first visible facet, and a second invisible facet. The second invisible facet is parallely opposed to the first visible facet. The second invisible facet comprises at least one of a single large transmitter coil, a sequential and random array of a plurality of relatively small transmitter coil, wherein the transmitter coil is capable of at least one of wirelessly powering one or more electrical loads coupled to the physical surface. In some embodiments, systems for mounting and reconfiguring electrical loads over wirelessly powered physical surfaces and methods therefor are disclosed, in accordance with the principles of present invention. In some specific embodiments, systems for mounting and reconfiguring electrical loads over at least one of custom-designed and retro-designed wirelessly powered physical surfaces and methods therefor are disclosed, in accordance with the principles of present invention. In specific some embodiments, design and implementation of systems for mounting and reconfiguring electrical loads over at least one of customized and retrofitted wirelessly powered physical surfaces and methods therefor are disclosed, in accordance with the principles of present invention.

In some embodiments, design and implementation of systems for mounting and reconfiguring electrical loads over at least one of an integrable and a mountable, and at least one of customized wireless power capable and retrofitted wireless power enabled physical surface, and a method therefor is disclosed.

For purposes of clarity and expediency, in the event that the system comprises at least one of an integrable and a mountable, customized wireless power capable physical surface thereby facilitating mounting and reconfiguration of electrical loads thereupon, the system may be hereinafter referred to as a customized system.

Likewise, for purposes of clarity and expediency, in the event that the system comprises at least one of an integrable and a mountable, retro-designed wireless power enabled physical surface thereby facilitating mounting and reconfiguration of electrical loads thereupon, the system may be hereinafter referred to as a retrofitted system.

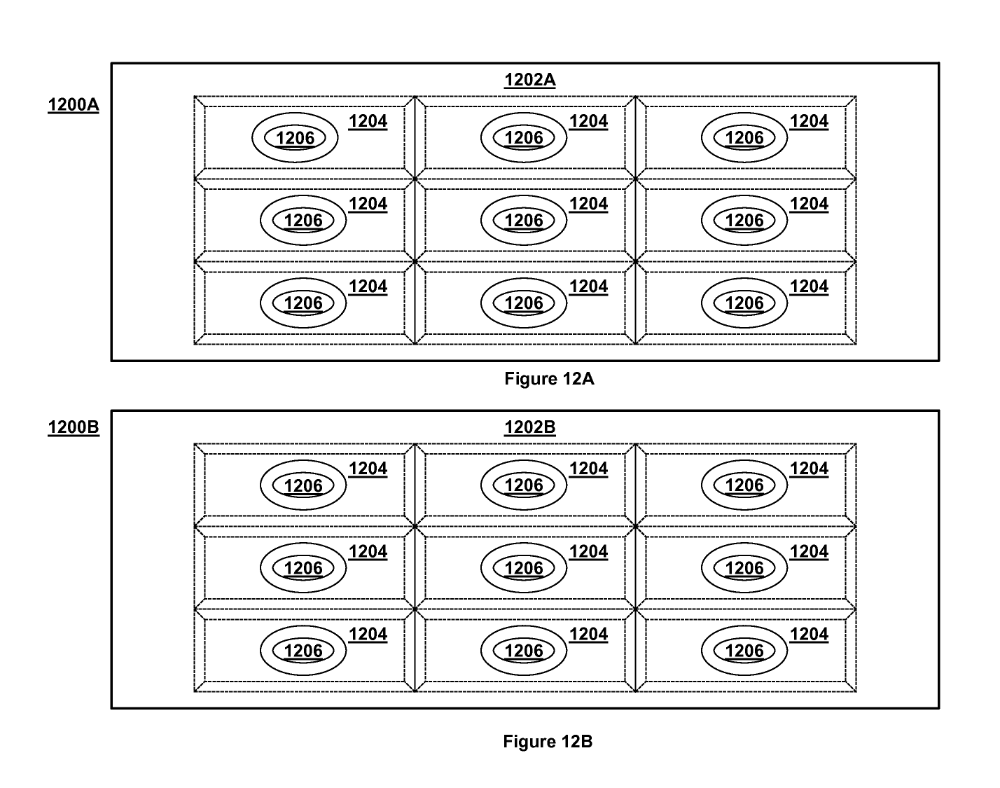

FIGS. 12A-B correspondingly depict the customized and retrofitted systems for mounting and positionally reconfiguring electrical loads over at least one of an integrable and a mountable, customized wireless power capable and retrofitted wireless power enabled physical surfaces with an identical first potential physical configuration therefor, according to one or more embodiments.

As depicted in FIGS. 12A-B, the customized and retrofitted systems 1200A and 1200B may correspondingly comprise physical surfaces 1202A and 1202B.

For example, and in no way limiting the scope of the invention, the physical surfaces 1202A and 1202B may be selected regions of at least one of false ceilings, artificial walls and other physical surfaces, such as surfaces of devices.

For example, and in no way limiting the scope of the invention, in some scenarios, the physical surfaces 1202A and 1202B may be at least one of vertically aligned (or erected), horizontally aligned (or spread) and variably aligned surfaces, such as a vertical wall, a horizontal surface, for instance floor, ceiling or table top, and an inclined (or slanted) wall or surface in a room of a building. Alternatively, in some scenarios, the physical surfaces 1202A and 1202B may be aligned in any fashion with respect, or relative, to a given three (or 3)-dimensional coordinate system.

In some embodiments, the physical surfaces 1202A and 1202B may possess any suitable material, structural, constitutional, dimensional, geometrical, alignment and orientational specifications. For example, and in no way limiting the scope of the invention, the physical surfaces 1202A and 1202B may possess the following material, structural, constitutional, dimensional, geometrical, alignment and orientational specifications, namely 1) material may be at least one of ceramic or porcelain, stone, metal, glass, perlite, wood, mineral wool, marble, and the like; 2) physical structure may be at least one of wall, ceiling, floor, table top, and the like; constitution may be at least one of compact modular tiles, panels and blocks, 3) alignment and orientation may be at least one of vertically aligned (or erected), such as vertical wall, horizontally aligned (or spread), such as horizontal wall or table top, and variably aligned, such as an inclined (or slanted) wall, or orientated in any fashion with respect, or relative, to a given three (or 3)-dimensional coordinate system; 4) geometry may be at least one of cube, cuboid and the like.

In some embodiments, the physical surfaces 1202A and 1202B may correspondingly comprise one or more physical surface modules 1204. For example, and in no way limiting the scope of the invention, the physical surface modules 1204 may be at least one of tiles, panels and blocks.

In some scenarios, the physical surfaces 1202A and 1202B may correspondingly comprise one or more tiles as the physical surface modules 1204.

The one or more tiles 1204 correspondingly constituting, and thus forming given selected regions of the physical surfaces 1202A and 1202B may be proximally juxtaposed to each other in the form of one or more horizontal rows and vertical columns, thereby resulting in the formation of a matrix- (or array-) like configuration of the one or more tiles 1204, wherein there may be a physical demarcation between each of the tiles 1204.

Each of the tiles 1204 correspondingly constituting, and thus forming the given selected regions of the physical surfaces 1202A and 1202B may comprise at least six principal facets, namely front, rear, top, bottom, left and right respectively.

In some specific embodiments involving construction of the customized system, one or more of the physical surface modules, for instance tiles, may be subjected to customized predesigning, preforming, prefitting and preassembly based on user-defined requirements.

Likewise, in some specific embodiments involving construction of the retro-designed system, one or more of the physical surface modules, for instance existing tiles, may be subjected to customized retro-forming, retro-fitting and retroassembly based on user-defined requirements.

The construction of the customized system 1200A comprises customized predesigning, preforming, prefitting and preassembly of the one or more tiles 1204, which collectively constitute, and thus form the given selected region of the physical surface 1202A.

Specifically, at least one transmitter coil 1206 may be fixedly removably coupled to the rear facet of each of the tiles 1204. For example, and in no way limiting the scope of the invention, one transmitter coil 1206 may be integrated to the rear facet of each of the tiles 1204.

In some embodiments, each of the one or more tiles 1204 preintegrated with at least one transmitter coil 1206 facilitates development of wireless power capability for the selected region of the physical surface 1202A.

In some embodiments, each transmitter coil may be selectively activated and deactivated using a controller 1212 (not shown here explicitly) thereby facilitating minimization of cross-interference between one or more transmitter coils 1206 juxtaposed to each other.

Likewise, the construction of the retro-designed system 12008 comprises customized retrodesigning, retrofitting and retroassembly of the one or more existing tiles 1204, which collectively constitute, and form the given selected region of the physical surface 1202B. Specifically, at least one transmitter coil 1206 may be fixedly removably coupled to the rear facet of each of the tiles 1204. For example, and in no way limiting the scope of the invention, one transmitter coil 1206 may be integrated to the rear facet of each of the tiles 1204.

In some embodiments, each of the one or more tiles 1204 retrointegrated with at least one transmitter coil 1206 facilitates transformation of physical surfaces via enablement of wireless power facility in the selected region of the physical surface 1202B.

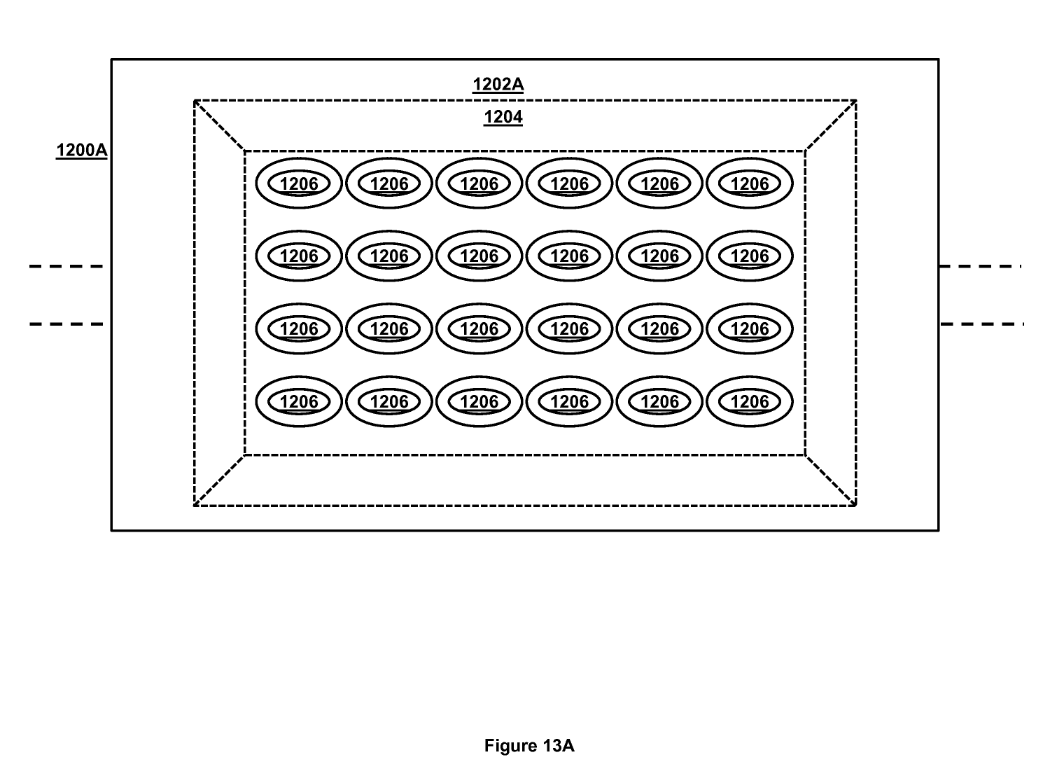

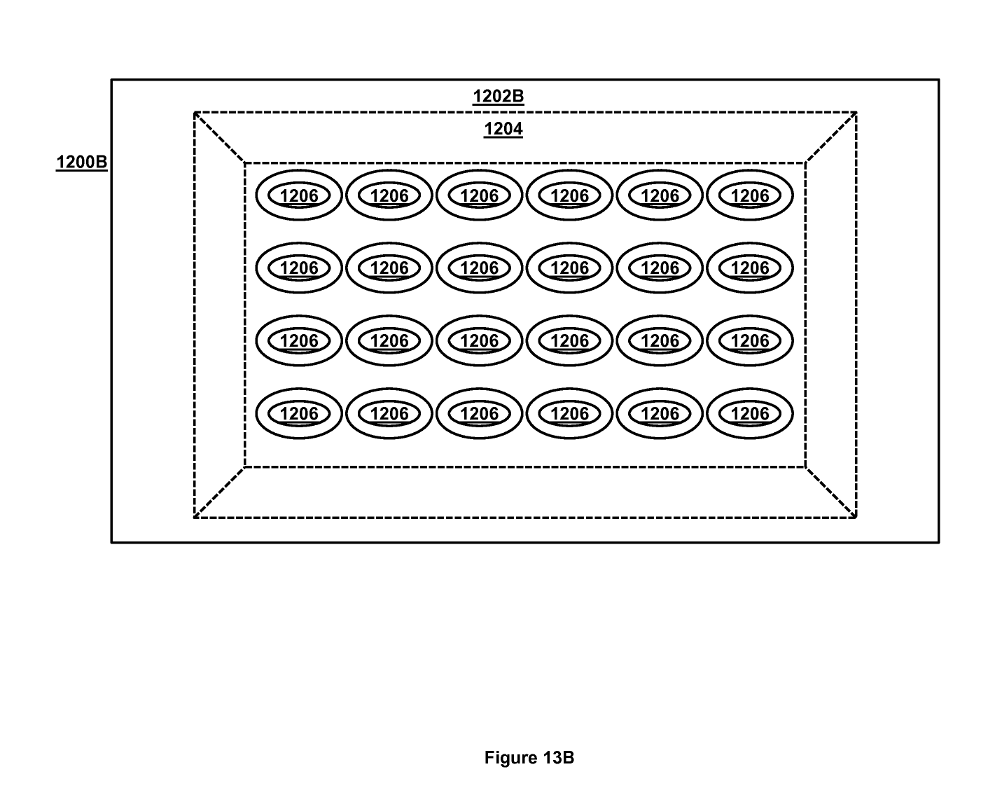

FIGS. 13A-B correspondingly depict the customized and retrofitted systems for mounting and reconfiguring electrical loads over at least one of an integrable and a mountable, customized wireless power capable and retrofitted wireless power enabled physical surfaces with an identical second potential physical configuration therefor, according to one or more embodiments.

In some scenarios, the physical surfaces 1202A and 1202B, of FIGS. 12A-B, may correspondingly comprise at least one of one or more panels and blocks as the physical surface modules 1204.

In some scenarios, the at least one of one or more panels and blocks 1204 correspondingly constituting, and thus forming given selected regions of the physical surfaces 1202A and 1202B may be proximally juxtaposed to each other in the form of one or more horizontal rows and vertical columns, thereby resulting in the formation of a matrix- (or array-) like configuration of the at least one of one or more panels and blocks 1204, wherein there may be a physical demarcation between each of the at least one of one or more panels and blocks 1204.

Each of the at least one or more panels and blocks 1204 correspondingly constituting, and thus forming the given selected regions of the physical surfaces 1202A and 1202B may comprise at least six principal facets, namely front, rear, top, bottom, left and right respectively.

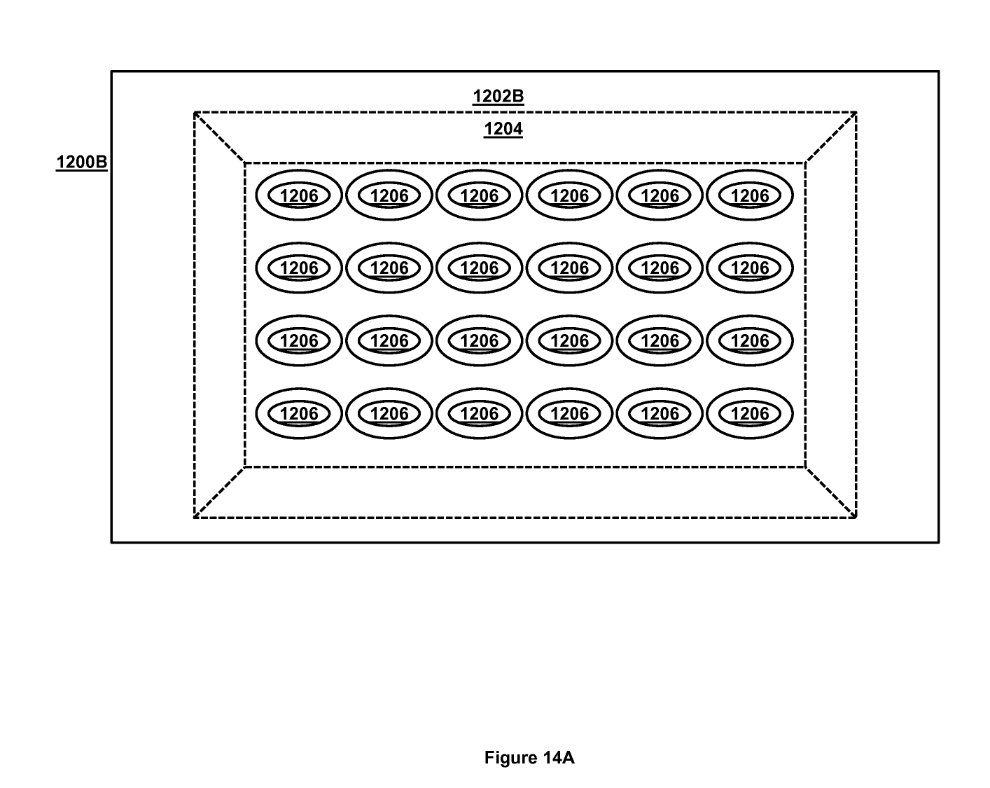

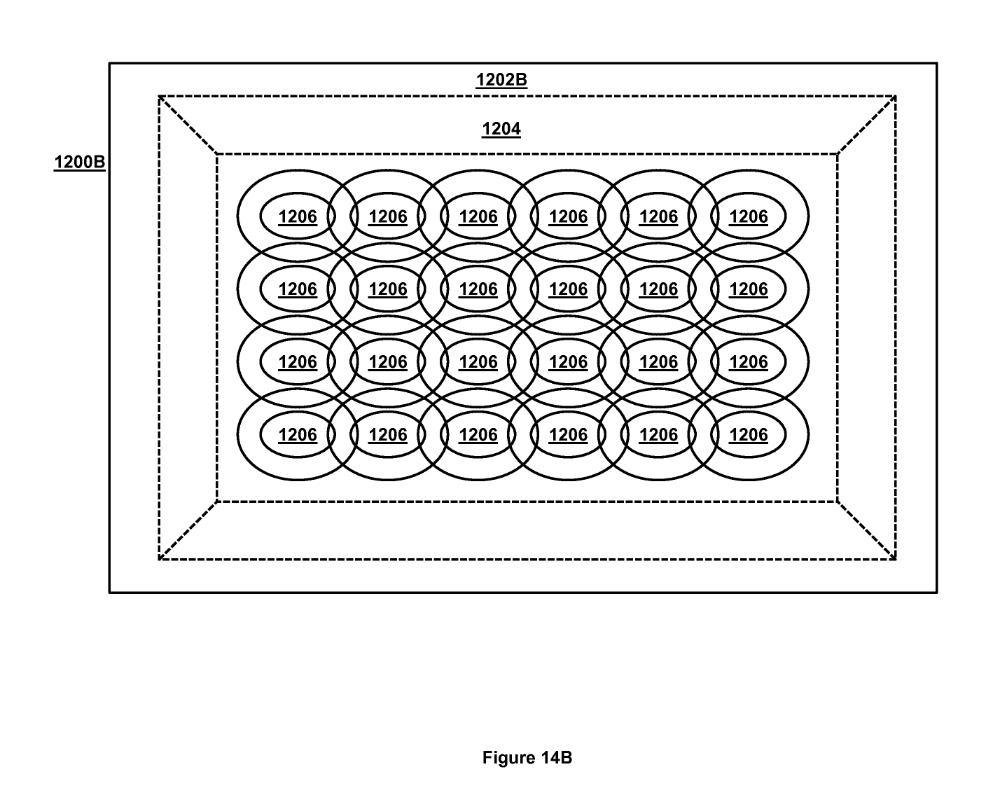

FIG. 14A depicts a first potential configuration in connection with the plurality of transmitter coils 1206 fixedly removably coupled to the rear facet of the at least one panel and block, according to one or more embodiments.

As depicted in the FIG. 14A, the plurality of transmitter coils 1206 may be fixedly removably coupled to the rear facet of the at least one panel and block thereby forming a sequential array- (or matrix-) like configuration, thereof.

FIG. 14B depicts a second potential configuration in connection with the plurality of transmitter coils 1206 fixedly removably coupled to the rear facet of the at least one panel and block, according to one or more embodiments.

As depicted in the FIG. 14B, the plurality of transmitter coils 1206 may be fixedly removably coupled to the rear facet of the at least one panel and block thereby forming a random array- (or matrix-) like configuration, thereof.

In some embodiments, upon construction of at least one of customized wireless capable and retrofitted wireless enabled physical surfaces, the physical surfaces may be at least one of externally mounted on existing physical surfaces, and integrated into predefined selected regions in the existing physical surfaces.

Each of one or more electrical loads (or load appliances) 1208 may comprise at least one receiver coil 1210. For example, and in no way limiting the scope of the invention, the electrical loads 1208 may be at least one of transparent and translucent simple light boxes and light boxes with at least one of LED and LCD display. Specifically, the simple light boxes 1208 may have at least one of visuals, icons, logos of merchandise and the like.

In some embodiments, deployment of the systems for mounting and reconfiguring electrical loads over at least one of customized and retrofitted wirelessly powered physical surfaces in a storefront (or shopfront) is disclosed, in accordance with the principles of the present invention.

In general, a storefront (or shopfront) is the facade or entryway of a retail store of a commercial building, typically including one or more display windows. A storefront functions to attract visual attention to a business and merchandise thereof.

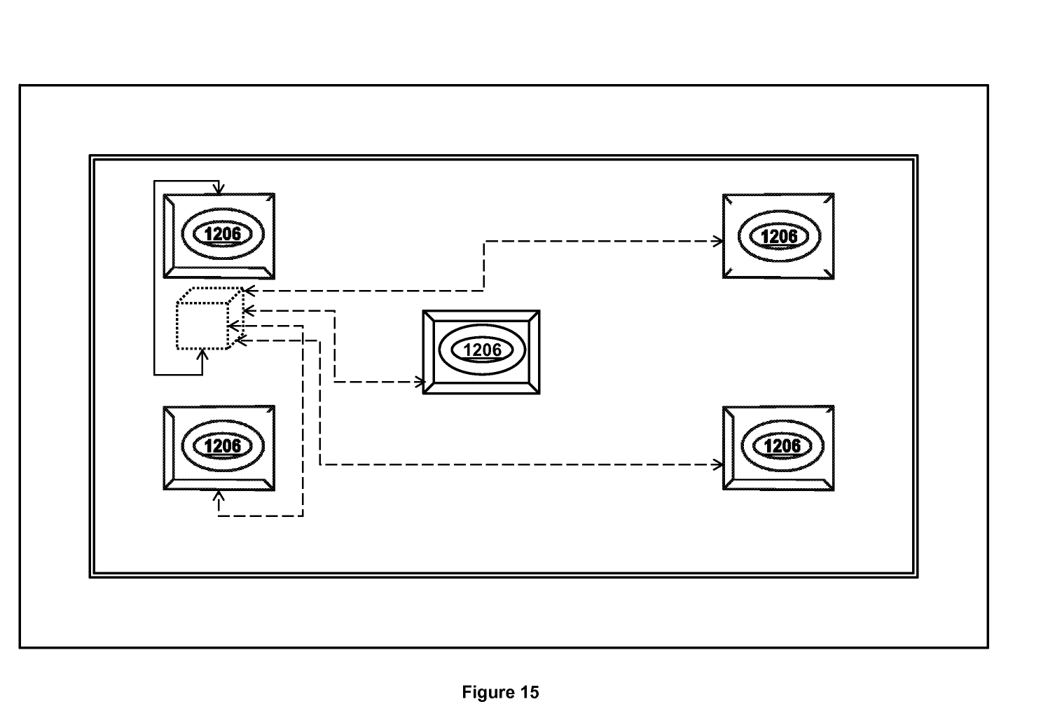

FIG. 15 depicts deployment of the systems for mounting and reconfiguring electrical loads over at least one of customized and retrofitted wirelessly powered physical surfaces in a storefront (or shopfront), according to one or more embodiments.

As depicted in FIG. 15, in use, at least one of transparent and translucent simple and at least one of LED and LCD display-type light boxes 1208 may be fixedly removably coupled to at least one of a vertically aligned surface 1202, for instance an erected wall, a horizontally aligned surface 1202, for instance a raised floor, and a variably aligned surface 1202, for instance an inclined or obliquely aligned or slanted wall, in the storefront (or shopfront) 1500. In some scenarios, the simple light boxes 1502 may have at least one of visuals, icons, logos of merchandise and the like printed thereupon.

The at least one of vertically aligned, horizontally aligned and variably aligned surface 1202 may be at least one of the customized wireless power capable and retrofitted wireless power enabled physical surface 102, at least one of custom-designed and retro-designed respectively, and implemented in accordance with the principles of the invention. By virtue of design and implementation, the at least one of customized wireless power capable and retrofitted wireless power enabled physical surface 102 facilitates at least one of random, sequential and selective positioning, relocation and interchangeable repositioning of the light boxes 108 over the at least one of customized wireless power capable and retrofitted wireless power enabled physical surface 102.

Advantageously, in some embodiments, deployment of the at least one of customized and retrofitted wirelessly powered physical surface 102 thereby facilitates adaptive, dynamic ornamental and thematic configuration of the storefront (or shopfront) 110. Still advantageously, in some embodiments, the systems 100A and 100B may facilitate at least one of mounting, replacing, removing, adding and reconfiguring, for instance at least one of positionally and orientationally, electrical loads over at least one of an integrable and a mountable, customized wireless power capable and retrofitted wireless power enabled physical surfaces. Still more advantageously, in some embodiments, flexible printed circuits (or flex circuits, flexible PCBs, flex print, flexi-circuits) may be integrated to the surfaces of the electrical loads, for instance surfaces of devices. In addition, the electrical loads may comprise wireless receivers. As a consequence, in operation, the systems 100A and 100B may facilitate wirelessly powering the electrical loads. In some embodiments, design and implementation of at least one of two (or 2)- and three (or 3) dimensional interactive mechanical puzzles, in accordance with the principles of the present invention. For example, and in no way limiting the scope of the invention, one or more mechanical puzzles, such as at least one of a put-together or assembly puzzles, for example, 2-D assembly puzzles, for instance, tangrams, anchors, T, jigsaws, and the like, 3-D assembly puzzle, for instance, soma, and the like, miscellaneous put-together, for instance, instant insanity, puzzle rings, and the like, matchstick puzzles; take-apart or disassembly puzzles, for instance, trick or secret opening puzzles, such as puzzle boxes, and the like, secret compartment puzzles, such as, slopes, coins, and the like, trick locks and keys, trick matchboxes, such as, matchsafes, trick knives; interlocking puzzle or interlocking solid puzzles, for instance, figurative, such as animals, objects, and the like, geometric objects, such as cube, and the like, 3-D jigsaw puzzles, burr puzzles, keychain puzzles, miscellaneous interlocking solid puzzles; disentanglement puzzles, for instance, cast iron and sheet metal puzzles, wire puzzles, such as Chinese rings, and the like, string puzzles (non-rigid disentanglement), miscellaneous disentanglement puzzles; sequential movement puzzles, for instance, solitaire puzzles, such as removing pegs, counters, etc. by jumping, counter puzzles, such as rearrange counters, pegs, etc. by jumping, sliding piece puzzles (2D and 3D).

In some scenarios involving use of at least one of two (or 2) and three (or 3)-dimensional interactive mechanical puzzles, each individual component of the puzzle may comprise a transmitter coil thereby facilitating wirelessly powering the components thereof. In some scenarios, the interactive mechanical puzzles may be installed at least one of indoors and outdoors and utilized accordingly. In some scenarios involving using or solving of one or more mechanical puzzles each success and failure may be reported or indicated to one or more users or solvers via at least one of an optical (or visual) alarm signal, for instance an alteration in the color of the light, and acoustic alarm signal.

### Example Computer System

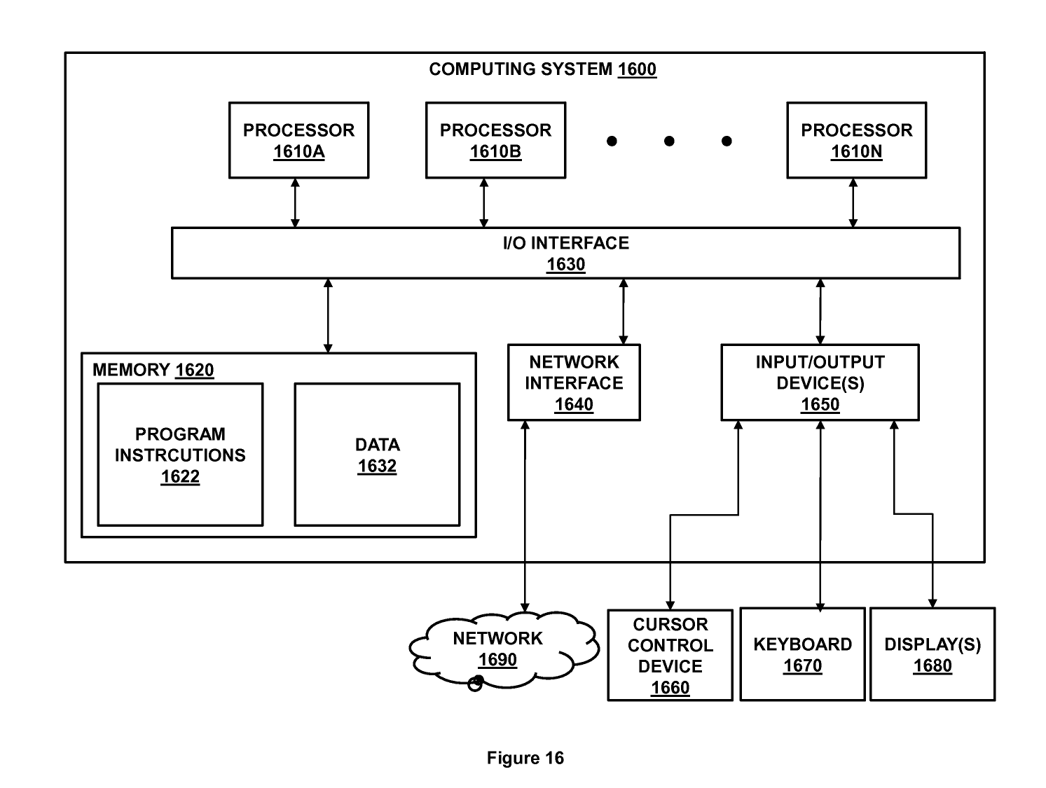

FIG. 16 depicts a computer system that may be a computing device and may be utilized in various embodiments of the present invention.

Various embodiments of the methods and systems for simultaneously wirelessly charging portable devices using custom-designed and retro-designed power control and supply assemblies and architectural structures facilitating hands-free operation of the portable devices and interaction therewith, as described herein, may be executed on one or more computer systems, which may interact with various other devices. One such computer system is computer system 1600 illustrated by FIG. 16, which may in various embodiments implement any of the elements or functionality illustrated in FIGS. 1-8. In various embodiments, computer system 1600 may be configured to implement one or more methods described above. The computer system 1600 may be used to implement any other system, device, element, functionality or method of the above-described embodiments. In the illustrated embodiments, computer system 1600 may be configured to implement one or more methods as processor-executable executable program instructions 1622 (e.g., program instructions executable by processor(s) 1610A-N) in various embodiments.

In the illustrated embodiment, computer system 1600 includes one or more processors 1610A-N coupled to a system memory 1620 via an input/output (I/O) interface 1630. The computer system 1600 further includes a network interface 1640 coupled to I/O interface 1630, and one or more input/output devices 1650, such as cursor control device 1660, keyboard 1670, and display(s) 1680. In various embodiments, any of components may be utilized by the system to receive user input described above. In various embodiments, a user interface (e.g., user interface) may be generated and displayed on display 1680. In some cases, it is contemplated that embodiments may be implemented using a single instance of computer system 1600, while in other embodiments multiple such systems, or multiple nodes making up computer system 1600, may be configured to host different portions or instances of various embodiments. For example, in one embodiment some elements may be implemented via one or more nodes of computer system 1600 that are distinct from those nodes implementing other elements. In another example, multiple nodes may implement computer system 1600 in a distributed manner.

In different embodiments, computer system 1600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 1600 may be a uniprocessor system including one processor 1610, or a multiprocessor system including several processors 1610 (e.g., two, four, eight, or another suitable number). Processors 1610A-N may be any suitable processor capable of executing instructions. For example, in various embodiments processors 1610 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 1610A-N may commonly, but not necessarily, implement the same ISA.

System memory 1620 may be configured to store program instructions 1622 and/or data 1632 accessible by processor 1610. In various embodiments, system memory 1620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1620. In other embodiments, program instructions and/or data may be received, sent or stored upon different types of computer-accessible media or on similar media separate from system memory 1620 or computer system 1600.

In one embodiment, I/O interface 1630 may be configured to coordinate I/O traffic between processor 1610, system memory 1620, and any peripheral devices in the device, including network interface 1640 or other peripheral interfaces, such as input/output devices 1650. In some embodiments, I/O interface 1630 may perform any necessary protocol, timing or other data transformations to convert data signals from one components (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments some or all of the functionality of I/O interface 1630, such as an interface to system memory 1620, may be incorporated directly into processor 1610.

Network interface 1640 may be configured to allow data to be exchanged between computer system 1600 and other devices attached to a network (e.g., network 1690), such as one or more external systems or between nodes of computer system 1600. In various embodiments, network 1690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1650 may, in some embodiments, include one or more display terminals, keyboards, keypads, touchpads, scanning devices, voice or optical recognition devices, or any other devices suitable for entering or accessing data by one or more computer systems 1600. Multiple input/output devices 1650 may be present in computer system 1600 or may be distributed on various nodes of computer system 1600. In some embodiments, similar input/output devices may be separate from computer system 1600 and may interact with one or more nodes of computer system 1600 through a wired or wireless connection, such as over network interface 1640.

Those skilled in the art will appreciate that computer system 1600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 1600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1600 may be transmitted to computer system 1600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A system for simultaneously wirelessly charging portable rechargeable devices whilst facilitating hands-free interactivity therewith, the system comprising:
at least one of a physical architectural structure mountable and integrable electric switch and socket assembly, the assembly comprising:
a rear panel comprising at least one of a switch socket outlet and display,
a front panel comprising a wireless charging unit with free positioning capability and improved coil and shield structure, and
a structurally adaptable coupling member for coupling the front panel with the rear panel;
at least a portable computing and communications device removably positioned on the wireless charging unit; and
a wireless speaker subsystem, wherein the display is wirelessly coupled to the portable computing and communications device.

2. The system of claim 1, wherein the display is a second screen display, and wherein the second screen display is at least one of a remote-controlled and touch-sensitive display.

3. The system of claim 1, wherein the front panel may also comprise of the display.

4. The system of claim 2, wherein the at least one of remote-controlled and touch-sensitive display facilitates hands-free operation of the portable computing and communication device and interaction therewith correspondingly via at least one of usage of a remote control and performance of touch action, whilst the portable computing and communications device is still subject to simultaneous wireless charging.

5. The system of claim 4, the at least one of remote-controlled and touch-sensitive display facilitates performance of one or more hands-free tasks, such as viewing, attending or responding to incoming calls, making outgoing calls, accessing, reading and responding to incoming messages, creating or writing and sending outgoing messages, accessing, retrieving, and executing, such as implementing, viewing and listening, mobile applications, multimedia files and the like, on the portable computing and communications device in at least one of a remote-controlled and touch-sensitive mode, whilst the portable computing and communications device is still subject to simultaneous wireless charging.

6. The system of claim 5, wherein the one or more hands-free tasks comprise at least one of 1) receiving multimedia information and communications, accessing, retrieving, viewing, listening, interacting via conversing with and attending to the received multimedia contents and communications, 2) at least one of creating new, modifying existing and stored multimedia contents and communications, 3) sending the at least one of newly created, modified and stored multimedia contents and communications and 4) installing, accessing, retrieving and implementing mobile applications.

7. The system of claim 1, wherein the wireless speaker subsystem facilitates wireless conversion of electrical audio signals into sound.

8. The system of claim 1, wherein the wireless charging unit facilitates seamless and simultaneous wireless charging of at least a pair of the portable rechargeable devices with adaptive free positioning capability.

9. The system of claim 1, wherein the wireless charging unit facilitates seamless and simultaneous wireless charging of at least a pair of the portable rechargeable devices based on one or more of wireless power transfer technologies.

10. The system of claim 1, wherein the seamless and simultaneous wireless charging of at least the pair of the portable rechargeable devices may be at least one technology, standard, protocol, device agnostic and a combination thereof.
